(19) United States
(12) Patent Application Publication
(10) Pub. No.: US 2025/0347771 A1
(43) Pub. Date: Nov. 13, 2025

(54) DISAMBIGUATION IN DOPPLER DIVISION MULTIPLE-ACCESS RADAR

(71) Applicant: Texas Instruments Incorporated, Dallas, TX (US)

(72) Inventors: Sai Ashwith Dharoor, Gadwal (IN); Sandeep Rao, Bangalore (IN)

(21) Appl. No.: 19/033,036

(22) Filed: Jan. 21, 2025

(30) Foreign Application Priority Data
May 7, 2024 (IN) 202441035982

(51) Int. Cl. G01S 7/35; G01S 13/02

(52) U.S. Cl. CPC G01S 7/354; G01S 2013/0263

(57) ABSTRACT

For systems, methods, and apparatus to improve disambiguation in Doppler division multiple-access radar, an example device includes a plurality of transmit antennas. The device includes a plurality of transmitters coupled to the plurality of transmit antennas and including respective phase shifters, the respective phase shifters configured to apply respective phase changes between chirps of a frame such that a phase spectrum for the plurality of transmitters is divided into a plurality of bands, at least three of the respective phase changes being non-consecutively distributed along divisions of the phase spectrum. Other examples are described.

### CROSS-REFERENCE TO RELATED APPLICATION

This patent application claims the benefit of and priority to Indian Provisional Patent Application No. 202441035982, filed May 7, 2024, which Application is hereby incorporated herein by reference in its entirety.

### TECHNICAL FIELD

This description relates generally to radar disambiguation and, more particularly, to systems, methods, and apparatus to improve disambiguation in Doppler division multiple-access radar.

### BACKGROUND

Doppler division multiple-access (DDMA) is a method of dividing a Doppler dimension or Doppler domain into multiple sub-divisions and assigning a transmitter to one sub-division. This may be performed by generating a sequence of chirps such that there is a linear increment (or decrement) in the starting phase of each chirp. Different transmitters may have different rates of phase increment or decrement. For each chirp, multiple transmitters are enabled. When received and processed according to a two-dimensional fast Fourier transform (FFT), DDMA signals from different transmitters will each occupy a different band in the Doppler domain. In this way, DDMA facilitates the simultaneous use of multiple transmitters within a single chirp while preventing the multiple transmitters from interfering with each other in the Doppler domain, also providing a capability to separate data from each transmitter.

### SUMMARY

For systems, methods, and apparatus to improve disambiguation in Doppler division multiple-access radar, an example device includes a plurality of transmit antennas. The device includes a plurality of transmitters coupled to the plurality of transmit antennas and including respective phase shifters, the respective phase shifters configured to apply respective phase changes between chirps of a frame such that a phase spectrum for the plurality of transmitters is divided into a plurality of bands, at least three of the respective phase changes being non-consecutively distributed along divisions of the phase spectrum. Other examples are described.

For systems, methods, and apparatus to improve disambiguation in Doppler division multiple-access radar, an example device includes a first transmitter having a first index in an array of transmitters, the first transmitter configured to transmit a first frame of chirps having a first phase change between the chirps of the first frame. The device includes a second transmitter having a second index in the array of transmitters consecutive to the first index, the second transmitter configured to transmit a second frame of chirps having a second phase change between the chirps of the second frame. The device includes a third transmitter having a third index in the array of transmitters consecutive to the second index, the third transmitter configured to transmit a third frame of chirps having a third phase change between the chirps of the third frame, a first difference between the first phase change and the second phase change being different than a second difference between the second phase change and the third phase change. Other examples are described.

For systems, methods, and apparatus to improve disambiguation in Doppler division multiple-access radar, an example method includes applying, with respective phase shifters of a plurality of transmitters, respective phase changes between chirps of a frame such that a phase spectrum for the plurality of transmitters is divided into a plurality of bands, at least three of the respective phase changes being non-consecutively distributed along divisions of the phase spectrum. The method includes transmitting, via a plurality of transmit antennas coupled to the plurality of transmitters, respective frames of chirps having the respective phase changes. Other examples are described.

### BRIEF DESCRIPTION OF THE DRAWINGS

FIG. 1 is a block diagram of an example radar system including example radar circuits.

FIG. 2A is a timing diagram of an example frame of example chirps.

FIG. 2B is a diagram of an example Doppler domain spectrum of a received frame of reflected chirps.

FIG. 3 is a diagram of an example Doppler domain spectrum of a received frame of reflected chirps transmitted by three transmitters implementing DDMA.

FIG. 4A is a diagram of a first example mapping of three example transmitters of a radar circuit to the Doppler domain spectrum of FIG. 3.

FIG. 4B is a diagram of a second example mapping of the three transmitters to the Doppler domain spectrum of FIG. 3.

FIG. 4C is a diagram of a third example mapping of the three transmitters to the Doppler domain spectrum of FIG. 3.

FIG. 5A is a diagram of a first example mapping of three example transmitters to an example Doppler domain spectrum of a received frame of reflected chirps transmitted by three example transmitters of a radar circuit when implementing DDMA with a single empty band.

FIG. 5B is a diagram of a second example mapping of the three transmitters to the Doppler domain spectrum of the received frame of reflected chirps transmitted by the three transmitters when implementing DDMA with a single empty band.

FIG. 5C is a diagram of a third example mapping of the three transmitters to the Doppler domain spectrum of the received frame of reflected chirps transmitted by the three transmitters when implementing DDMA with a single empty band.

FIG. 5D is a diagram of a fourth example mapping of the three transmitters to the Doppler domain spectrum of the received frame of reflected chirps transmitted by the three transmitters when implementing DDMA with a single empty band.

FIG. 6 is a diagram of an example Doppler domain spectrum of a received frame of reflected chirps transmitted by four example transmitters implementing DDMA with two contiguous empty bands and four contiguous occupied bands.

FIG. 7 is a block diagram of an example radar transceiver integrated circuit (IC) that can implement any of the radar circuits of FIG. 1.

FIG. 8A is a diagram of an example phase spectrum of the transmitters of FIG. 7 when implementing DDMA with at least two non-contiguous empty bands.

FIG. 8B is a diagram of an example Doppler domain spectrum of a received frame of reflected chirps transmitted by the transmitters of FIG. 7 when implementing DDMA with at least two non-contiguous empty bands.

FIG. 9A is a diagram of a first example mapping of the transmitters of FIG. 7 to an example Doppler domain spectrum of a received frame of reflected chirps transmitted by the transmitters of FIG. 7 when implementing DDMA with at least two non-contiguous empty bands.

FIG. 9B is a diagram of a second example mapping of the transmitters of FIG. 7 to the Doppler domain spectrum of a received frame of reflected chirps transmitted by the transmitters of FIG. 7 when implementing DDMA with at least two non-contiguous empty bands.

FIG. 9C is a diagram of a third example mapping of the transmitters of FIG. 7 to the Doppler domain spectrum of a received frame of reflected chirps transmitted by the transmitters of FIG. 7 when implementing DDMA with at least two non-contiguous empty bands.

FIG. 9D is a diagram of a fourth example mapping of the transmitters of FIG. 7 to the Doppler domain spectrum of a received frame of reflected chirps transmitted by the transmitters of FIG. 7 when implementing DDMA with at least two non-contiguous empty bands.

FIG. 9E is a diagram of a fifth example mapping of the transmitters of FIG. 7 to the Doppler domain spectrum of a received frame of reflected chirps transmitted by the transmitters of FIG. 7 when implementing DDMA with at least two non-contiguous empty bands.

FIG. 9F is a diagram of a sixth example mapping of the transmitters of FIG. 7 to the Doppler domain spectrum of a received frame of reflected chirps transmitted by the transmitters of FIG. 7 when implementing DDMA with at least two non-contiguous empty bands.

FIG. 10A is a diagram of an example Doppler domain spectrum of a received frame of reflected chirps transmitted by sixteen transmitters when implementing DDMA with eight non-contiguous empty bands.

FIG. 10B is a diagram of an example Doppler domain spectrum of a received frame of reflected chirps transmitted by sixteen transmitters when implementing DDMA with eight contiguous empty bands.

FIG. 11 is a diagram of an example graph illustrating auto-correlation of the Doppler domain spectrum of FIG. 10A and the Doppler domain spectrum of FIG. 10B to perform DDMA disambiguation.

FIG. 12 is a diagram of an example graph illustrating the probability of correctly disambiguating sixteen transmitters with the Doppler domain spectrum of FIG. 10A and the Doppler domain spectrum of FIG. 10B with respect to signal-to-noise ratio (SNR).

FIG. 13A is a diagram of an example Doppler domain spectrum of a received frame of reflected chirps transmitted by eight transmitters when implementing DDMA with four non-contiguous empty bands.

FIG. 13B is a diagram of an example Doppler domain spectrum of a received frame of reflected chirps transmitted by eight transmitters when implementing DDMA with four contiguous empty bands and eight contiguous occupied bands.

FIG. 14 is a diagram of an example graph illustrating auto-correlation of the Doppler domain spectrum of FIG. 13A and the Doppler domain spectrum of FIG. 13B to perform DDMA disambiguation.

FIG. 15 is a diagram of an example graph illustrating the probability of correctly disambiguating eight transmitters with the Doppler domain spectrum of FIG. 13A and the Doppler domain spectrum of FIG. 13B with respect to SNR.

FIG. 16A is a diagram of an example Doppler domain spectrum of a received frame of reflected chirps transmitted by eight transmitters when implementing DDMA with eight non-contiguous empty bands.

FIG. 16B is a diagram of an example graph illustrating auto-correlation of the Doppler domain spectrum of FIG. 13A and the Doppler domain spectrum of FIG. 16A to perform DDMA disambiguation.

FIG. 17 is a flowchart representative of example machine-readable instructions or example operations that may be at least one of executed, instantiated, or performed using an example programmable circuitry implementation of the radar transceiver IC of FIG. 7.

FIG. 18 is a block diagram of an example processing platform including programmable circuitry structured to execute, instantiate, or perform the example machine-readable instructions or perform the example operations of FIG. 17 to implement the transceiver IC of FIG. 7.

The drawings are not necessarily to scale. Generally, the same reference numbers in the drawing(s) and this description refer to the same or similar (in terms of at least one of functional or structural) features or parts. Although the drawings show regions with clean lines and boundaries, some or all of these lines and boundaries may be idealized. In reality, the boundaries or lines may be unobservable, blended or irregular.

### DETAILED DESCRIPTION

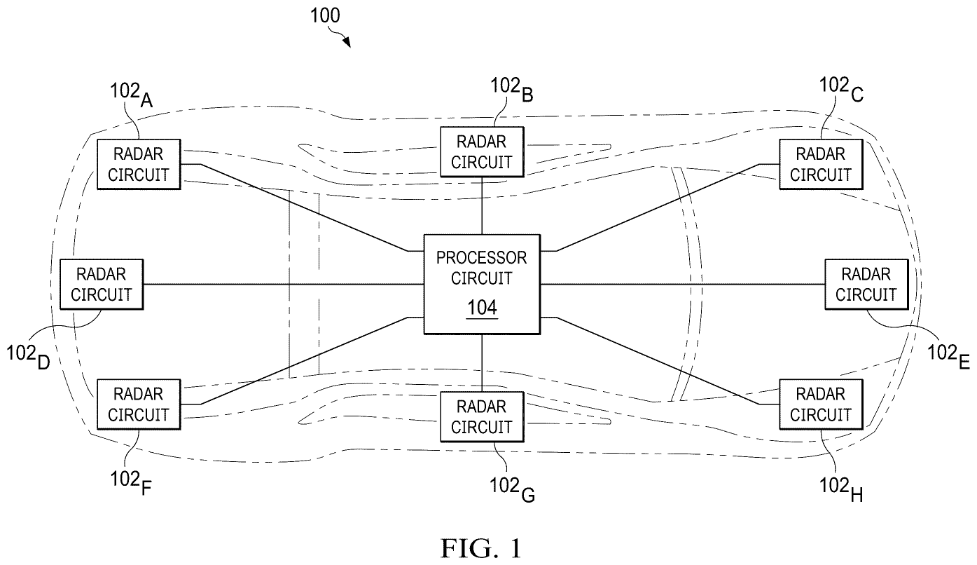

FIG. 1 is a block diagram of an example radar system 100 including example radar circuits 102_{A}, 102_{B}, 102_{C}, 102_{D}, 102_{E}, 102_{F}, 102_{G}, 102_{H}. In the example of FIG. 1, the radar system 100 also includes an example processor circuit 104. In the example of FIG. 1, one or more of the radar circuits 102_{A}, 102_{B}, 102_{C}, 102_{D}, 102_{E}, 102_{F}, 102_{G}, 102_{H} may be referred to as a radar front end and the processor circuit 104 may be referred to as a radar backend. In some examples, one or more of the radar circuits 102_{A}, 102_{B}, 102_{C}, 102_{D}, 102_{E}, 102_{F}, 102_{G}, 102_{H} and the processor circuit 104 are implemented separately and may be adapted to be coupled together. Also or alternatively, one or more of the radar circuits 102_{A}, 102_{B}, 102_{C}, 102_{D}, 102_{E}, 102_{F}, 102_{G}, 102_{H} is implemented with an instance of the processor circuit 104, for example, in a single chip package or on a system-on-chip (SoC) (e.g., a single IC). In examples in which one or more of the radar circuits 102_{A}, 102_{B}, 102_{C}, 102_{D}, 102_{E}, 102_{F}, 102_{G}, 102_{H} are implemented with an instance of the processor circuit 104 on a SoC, the one or more of the radar circuits 102_{A}, 102_{B}, 102_{C}, 102_{D}, 102_{E}, 102_{F}, 102_{G}, 102_{H} may correspond to a sub-circuit of the IC that forms the SoC.

In the illustrated example of FIG. 1, the processor circuit 104 is coupled to each of the radar circuits 102_{A}, 102_{B}, 102_{C}, 102_{D}, 102_{E}, 102_{F}, 102_{G}, 102_{H} (e.g., via an interface) that may facilitate any suitable communication technique (e.g., a serial interface, a parallel interface, etc.) and is configured to at least one of receive data from or transmit data to each of the radar circuits 102_{A}, 102_{B}, 102_{C}, 102_{D}, 102_{E}, 102_{F}, 102_{G}, 102_{H}. In some examples, the interface between the processor circuit 104 and each of the radar circuits 102_{A}, 102_{B}, 102_{C}, 102_{D}, 102_{E}, 102_{F}, 102_{G}, 102_{H} may be a high-speed serial interface such as a low-voltage differential signaling (LVDS) interface. Also or alternatively, the interface between the processor circuit 104 and each of the radar circuits 102_{A}, 102_{B}, 102_{C}, 102_{D}, 102_{E}, 102_{F}, 102_{G}, 102_{H} may be a lower speed interface such as a serial peripheral interface (SPI).

In the illustrated example of FIG. 1, each of the radar circuits 102_{A}, 102_{B}, 102_{C}, 102_{D}, 102_{E}, 102_{F}, 102_{G}, 102_{H} includes functionality to generate one or more chirp signals as described herein. In the example of FIG. 1, each of the radar circuits 102_{A}, 102_{B}, 102_{C}, 102_{D}, 102_{E}, 102_{F}, 102_{G}, 102_{H} also includes functionality to generate one or more digital intermediate frequency (IF) signals (sometimes referred to as de-chirped signals, beat signals, or raw radar signals) from reflected chirps. Also, each of the radar circuits 102_{A}, 102_{B}, 102_{C}, 102_{D}, 102_{E}, 102_{F}, 102_{G}, 102_{H} includes functionality to perform at least a portion of signal processing of received radar signals (e.g., the reflected chirps, the digital IF signals, etc.), and to provide the results of the signal processing to the processor circuit 104. In some examples, each of the radar circuits 102_{A}, 102_{B}, 102_{C}, 102_{D}, 102_{E}, 102_{F}, 102_{G}, 102_{H} includes functionality to perform a range FFT for each received frame (e.g., each sequence of chirps of the frame). Also or alternatively, each of the radar circuits 102_{A}, 102_{B}, 102_{C}, 102_{D}, 102_{E}, 102_{F}, 102_{G}, 102_{H} includes functionality to perform a Doppler FFT for each received frame (e.g., after performing, and on a result of, the range FFTs).

In the illustrated example of FIG. 1, the processor circuit 104 includes functionality to process data received from one or more of the radar circuits 102_{A}, 102_{B}, 102_{C}, 102_{D}, 102_{E}, 102_{F}, 102_{G}, 102_{H} to, for example, determine one or more of a distance, velocity, or angle of any objects detected by the radar system 100. Also or alternatively, the processor circuit 104 includes functionality to perform post processing of information concerning the detected objects, such as tracking objects or determining rate and direction of movement. In some examples, the processor circuit 104 performs at least one of velocity disambiguation or collision detection. For example, according to aspects of the present description, at least one of velocity disambiguation or collision detection is facilitated by providing for at least two non-contiguous empty bands in a Doppler spectrum (e.g., non-contiguous empty bands in an output signal of a Doppler FFT performed on a received frame).

In the illustrated example of FIG. 1, the processor circuit 104 includes one or more processors or combinations of processors for processing data received from one or more of the radar circuits 102_{A}, 102_{B}, 102_{C}, 102_{D}, 102_{E}, 102_{F}, 102_{G}, 102_{H}. In the example of FIG. 1, the processor circuit 104 also provides data to one or more of the radar circuits 102_{A}, 102_{B}, 102_{C}, 102_{D}, 102_{E}, 102_{F}, 102_{G}, 102_{H}. For example, the processor circuit 104 may include one or more of a digital signal processor (DSP), a microcontroller, a SoC combining both a DSP and a microcontroller, a field-programmable gate array (FPGA), or any combination of the foregoing.

In the illustrated example of FIG. 1, the radar system 100 can be implemented in a variety of applications such as advanced driver assistance systems (ADAS) and automotive vehicles to measure distance, velocity, acceleration, and angle. In some examples, the radar system 100 can be implemented in other vehicles (e.g., aircraft or marine), industrial use-cases, imaging radar, robotics, building automation, security and surveillance, or medical devices for blood pressure monitoring, emotional monitoring, and sleep monitoring. In the example of FIG. 1, the radar system 100 is implemented in an example automotive application. For example, the radar circuits 102_{A}, 102_{B}, 102_{C}, 102_{D}, 102_{E}, 102_{F}, 102_{G}, 102_{H} are positioned around a vehicle to provide automotive driver assistance. FIG. 1 shows an example use-case with eight radar circuits, while some vehicles may have only corner radar circuits 102_{A}, 102_{C}, 102_{F}, 102_{H} and/or front radar circuit 102_{E}.

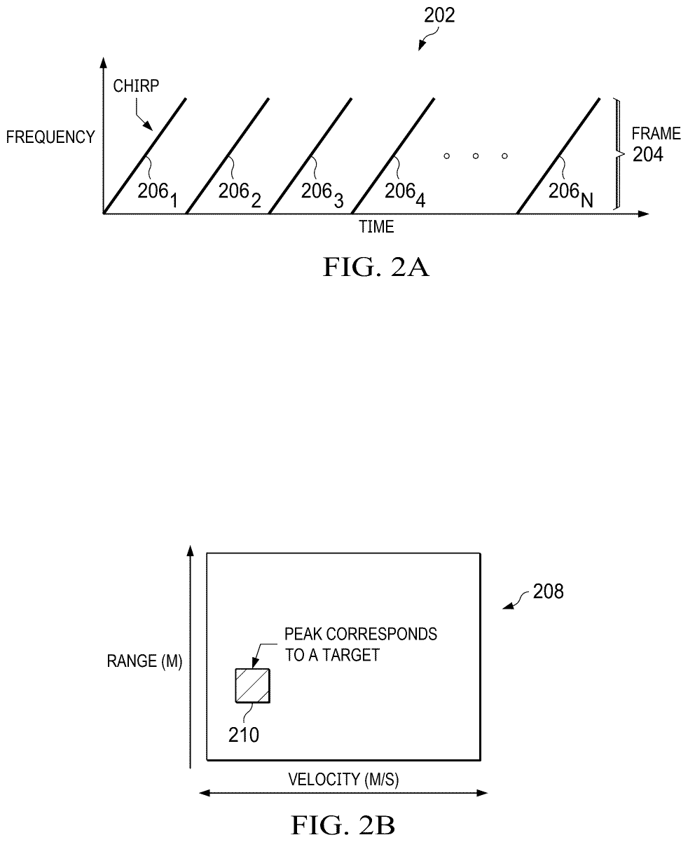

In the illustrated example of FIG. 1, one or more of the radar circuits 102_{A}, 102_{B}, 102_{C}, 102_{D}, 102_{E}, 102_{F}, 102_{G}, 102_{H} can implement DDMA as described herein. For example, one or more of the radar circuits 102_{A}, 102_{B}, 102_{C}, 102_{D}, 102_{E}, 102_{F}, 102_{G}, 102_{H} can generate, and transmit into an environment, a sequence of chirps, sometimes referred to as a frame of chirps, such that there is a linear increment (or decrement) in the starting phase of each chirp. FIG. 2A is a timing diagram 202 of an example frame 204 of example chirps 206₁-206_{N}.

In the illustrated example of FIG. 2A, the timing diagram 202 depicts frequency versus time. As illustrated in FIG. 2A, a chirp is a signal where the frequency of the signal varies linearly with time. In the example of FIG. 2A, the frame 204 refers to a series of (e.g., N) chirps that are equidistantly spaced in time. As such, in some examples, the frame 204 is referred to as a frequency modulated continuous wave (FMCW) frame. In the example of FIG. 2A, the frame 204 includes a linear increment (or decrement) in phase of each chirp of the frame 204. As such, the phase change between consecutive chirps of the frame 204 is equal (e.g., ΔΦ_{C1-C2}=ΔΦ_{C2-C3}=ΔΦ_{C3-C4} . . . =ΔΦ_{C(N-1)-CN)}.

When the frame 204 of the chirps 206₁-206_{N} is transmitted into an environment and reflected off an object, a received frame may be processed according to a two-dimensional FFT and represented in the Doppler domain. FIG. 2B is a diagram of an example Doppler domain spectrum 208 of a received frame of reflected chirps. To generate the Doppler domain spectrum 208 (sometimes referred to as a range-Doppler heatmap), a radar circuit can process a received frame of reflected chirps across the multiple reflected chirps. In the example of FIG. 2B, the Doppler domain spectrum 208 is a three-dimensional graph that depicts range in meters (m) versus velocity in meters per second (m/s) where signals in the two-dimensional range-velocity field have an associated magnitude providing a third dimension. Signal peaks in the Doppler domain spectrum 208 correspond to targets in a field of view of a radar circuit. For example, the Doppler domain spectrum 208 includes an example representation 210 of an object in a field of view of a radar circuit.

In modern applications, radar circuits include multiple transmitters and multiple receivers. DDMA provides a method to divide the Doppler domain spectrum into multiple sub-divisions and assign each of the multiple transmitters to a respective sub-division. For example, DDMA is widely used in automotive FMCW radar applications. In DDMA, multiple transmitters transmit a frame of chirps simultaneously where each transmitter imparts a linear phase change (Φ) across the chirps of the frame as described above. For the k^{th} indexed transmitter, Φₖ=2πk/N_{TX} where N_{TX} is the number of transmitters and k is an index value in a N_{TX} range of [1:N] corresponding to a transmitter that will be transmitting a signal with a phase change Ok. As such, the phase changes for the N_{TX} transmitters increase linearly with a direct proportionality to transmitter indices. DDMA results in the Doppler domain spectrum being divided into N_{TX} bands where each target detected by a radar circuit results in N_{TX} peaks or representations and each peak (e.g., image) corresponds to one of the N_{TX} transmitters.

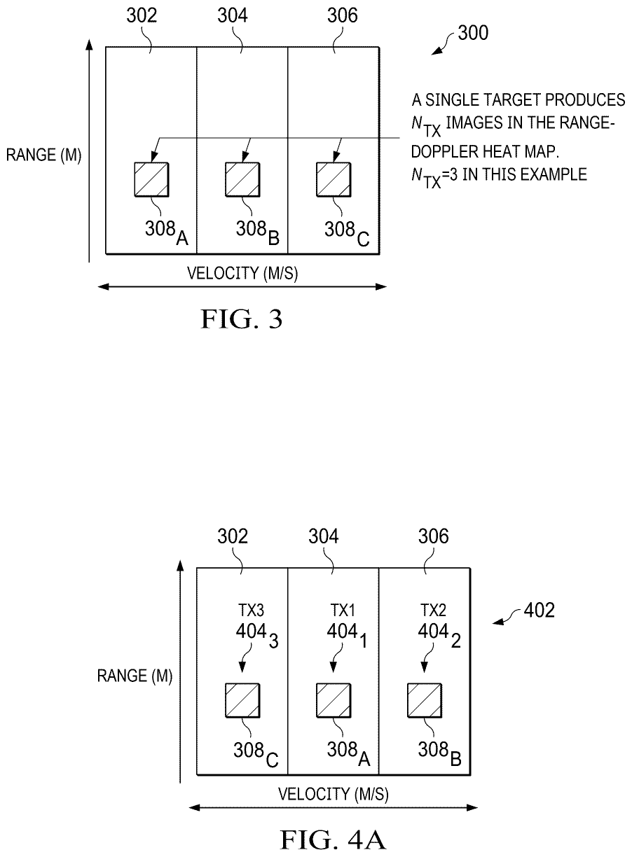

FIG. 3 is a diagram of an example Doppler domain spectrum 300 of a received frame of reflected chirps transmitted by three transmitters implementing DDMA. In the example of FIG. 3, the origin of the velocity axis of the Doppler domain spectrum 300 is in the middle of the velocity axis. As such, values to the left of the origin of the velocity axis are less than the value of the origin (e.g., zero) and values to the right of the origin of the velocity axis are greater than the value of the origin. In the example of FIG. 3, the Doppler domain spectrum 300 includes a first example band 302, a second example band 304, and a third example band 306.

In the illustrated example of FIG. 3, each of the bands of the Doppler domain spectrum 300 includes a representation of an object (sometimes referred to as a target) that reflected chirps transmitted into an environment. For example, the first band 302 includes a first example representation 308_{A} of the object, the second band 304 includes a second example representation 308_{B} of the object, and the third band 306 includes a third example representation 308_{C} of the object. Also, the representation of the object in each band corresponds to one of the transmitters that transmitted the chirps into the environment.

As illustrated in FIG. 3, DDMA signals from different transmitters will each occupy different bands in the Doppler domain spectrum. In this way, DDMA facilitates the simultaneous use of multiple transmitters with a single chirp while preventing the multiple transmitters from interfering with each other in the Doppler domain. Mapping each of the transmitters to a corresponding band of a Doppler representation of received data (e.g., identifying which transmitter corresponds to which band) is important for post processing of received data (e.g., to determine velocity, to determine angle of arrival, etc.).

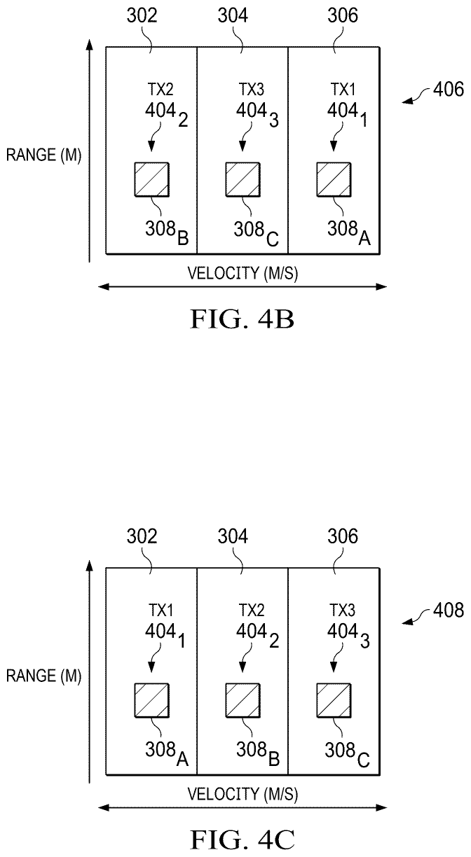

However, the mapping of transmitters to representations of an object depends on the velocity of a target, which may be unknown at the time mapping is performed. As such, there are multiple potential mappings for a given number of transmitters. For example, FIG. 4A is a diagram of a first example mapping 402 of three example transmitters 404₁-404₃ of a radar circuit to the Doppler domain spectrum 300 of FIG. 3.

In the illustrated example of FIG. 4A, the first representation 308_{A} corresponds to an example first indexed transmitter 404₁ of the radar circuit and the first indexed transmitter 404₁ is mapped to the second band 304 of the Doppler domain spectrum 300. For example, a radar circuit may include an array of transmitters and an array of receivers where each transmitter of the array of transmitters and each receiver of the array of receivers is assigned an index (e.g., ranging from 0 to N−1, from 1 to N, etc.). As such, indices increase consecutively from an initial index (e.g., a zero indexed transmitter is followed by a first indexed transmitter, a first indexed transmitter is followed by a second indexed transmitter, etc.).

In the illustrated example of FIG. 4A, the second representation 308_{B} corresponds to an example second indexed transmitter 404₂ of the radar circuit and the second indexed transmitter 404₂ is mapped to the third band 306 of the Doppler domain spectrum 300. In the example of FIG. 4A, the third representation 308_{C} corresponds to an example third indexed transmitter 404₃ of the radar circuit and the third indexed transmitter 404₃ is mapped to the first band 302 of the Doppler domain spectrum 300. If the three transmitters 404₁-404₃ are mapped to the Doppler domain spectrum 300 according to the first mapping 402, then a radar circuit can determine that the velocity of the target is between negative V_{MAX}/3 and V_{MAX}/3.

FIG. 4B is a diagram of a second example mapping 406 of the three transmitters 404₁-404₃ to the Doppler domain spectrum 300 of FIG. 3. In the example of FIG. 4B, the first representation 308_{A} corresponds to the first indexed transmitter 404₁ of the radar circuit and the first indexed transmitter 404₁ is mapped to the third band 306 of the Doppler domain spectrum 300. Also, in the example of FIG. 4B, the second representation 308_{B} corresponds to the second indexed transmitter 404₂ of the radar circuit and the second indexed transmitter 404₂ is mapped to the first band 302 of the Doppler domain spectrum 300. In the example of FIG. 4B, the third representation 308_{C} corresponds to the third indexed transmitter 404₃ of the radar circuit and the third indexed transmitter 404₃ is mapped to the second band 304 of the Doppler domain spectrum 300. If the three transmitters 404₁-404₃ are mapped to the Doppler domain spectrum 300 according to the second mapping 406, then a radar circuit can determine that the velocity of the target is between V_{MAX}/3 and V_{MAX}.

FIG. 4C is a diagram of a third example mapping 408 of the three transmitters 404₁-404₃ to the Doppler domain spectrum 300 of FIG. 3. In the example of FIG. 4C, the first representation 308_{A} corresponds to the first indexed transmitter 404₁ of the radar circuit and the first indexed transmitter 404₁ is mapped to the first band 302 of the Doppler domain spectrum 300. Also, in the example of FIG. 4C, the second representation 308_{B} corresponds to the second indexed transmitter 404₂ of the radar circuit and the second indexed transmitter 404₂ is mapped to the second band 304 of the Doppler domain spectrum 300. In the example of FIG. 4C, the third representation 308_{C} corresponds to the third indexed transmitter 404₃ of the radar circuit and the third indexed transmitter 404₃ is mapped to the third band 306 of the Doppler domain spectrum 300. If the three transmitters 404₁-404₃ are mapped to the Doppler domain spectrum 300 according to the third mapping 408, then a radar circuit can determine that the velocity of the target is between negative V_{MAX} and negative V_{MAX}/3.

As illustrated in FIGS. 4A-4C, disambiguating between received data presents a challenge and is important for post processing of received data. Disambiguation is especially important in operating environments with interfering signals, such as automotive radar where many vehicles are transmitting in the same frequency band. Each vehicle's radar system can perform better object detection if the system can distinguish reflections of its own transmitted signals from the signals transmitted by other vehicles' radars and from the multipath reflections of its own transmitted signals. One approach to perform DDMA disambiguation is to control transmitters of a radar circuit to transmit signals with respective phase changes that cause one or more contiguous empty bands to occur in the Doppler domain. In DDMA with one or more contiguous empty bands, multiple transmitters transmit a frame of chirps simultaneously where each transmitter imparts a linear phase change (Φ) across the chirps of the frame as described above. For the k^{th} indexed transmitter, Φₖ=2πk/N_{TX}+N_{EB} where N_{TX} is the number of transmitters, N_{EB} is the number of contiguous empty bands, and k is an index value in a range of [1:N] corresponding to a transmitter that will be transmitting a signal with a phase change Ok. As such, the phase changes for the N_{TX} transmitters increase linearly with a direct proportionality to transmitter indices. DDMA with one or more contiguous empty bands results in the Doppler domain spectrum being divided into the sum of N_{TX} and N_{EB} bands with N_{EB} bands being contiguous and empty (e.g., lacking a representation of the target). Also, each target detected by a radar circuit results in N_{TX} peaks or representations and each peak (e.g., image) corresponds to one of the N_{TX} transmitters as in DDMA.

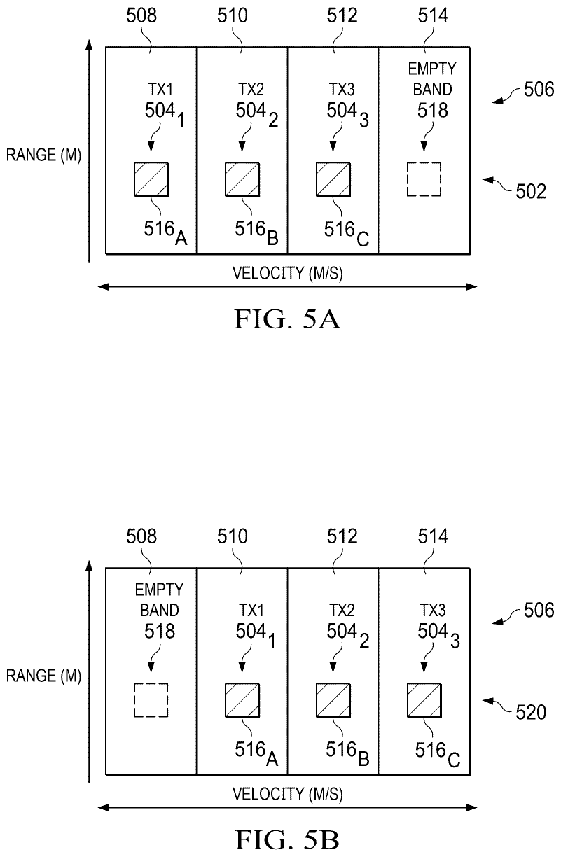

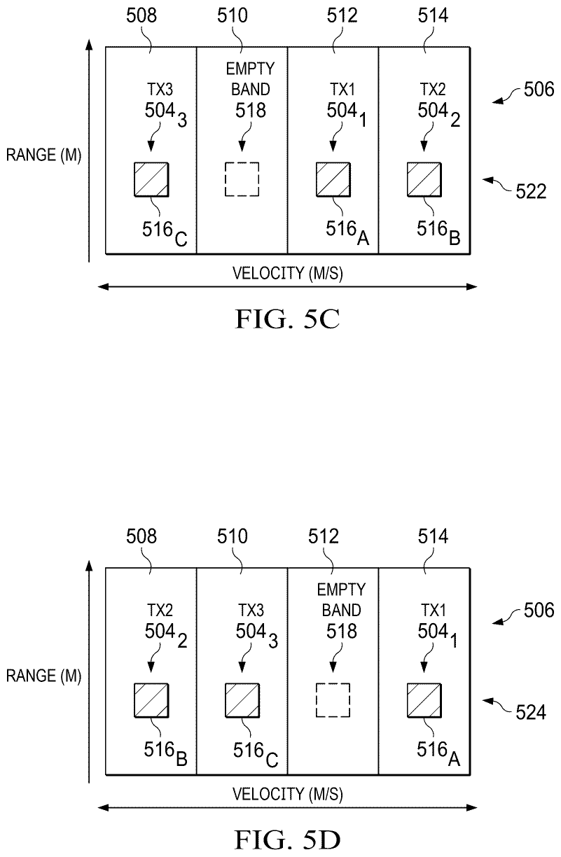

FIG. 5A is a diagram of a first example mapping 502 of three example transmitters 504₁-504₃ to an example Doppler domain spectrum 506 of a received frame of reflected chirps transmitted by three example transmitters 504₁-504₃ of a radar circuit when implementing DDMA with a single empty band. In the example of FIG. 5A, the Doppler domain spectrum 506 includes a first example band 508, a second example band 510, a third example band 512, and a fourth example band 514. Also, some of the bands of the Doppler domain spectrum 506 include a representation of an object that reflected chirps transmitted into an environment.

In the illustrated example of FIG. 5A, the representation of the object in some of the bands corresponds to one of the transmitters that transmitted the chirps into the environment. According to the first mapping 502 of FIG. 5A, an example first indexed transmitter 504₁ of the radar circuit is mapped to the first band 508 of the Doppler domain spectrum 506 and corresponds to a first example representation 516_{A} of the object. In the example of FIG. 5A, an example second indexed transmitter 504₂ of the radar circuit is mapped to the second band 510 of the Doppler domain spectrum 506 and corresponds to a second example representation 516_{B} of the object.

In the illustrated example of FIG. 5A, an example third indexed transmitter 504₃ of the radar circuit is mapped to the third band 512 of the Doppler domain spectrum 506 and corresponds to a third example representation 516_{C} of the object. Also, the fourth band 514 of the Doppler domain spectrum 506 is mapped to an example empty band 518. If the three transmitters 504₁-504₃ and the empty band 518 are mapped to the Doppler domain spectrum 506 according to the first mapping 502, then a radar circuit can determine that the velocity of the target is between negative V_{MAX} and negative V_{MAX}/2.

FIG. 5B is a diagram of a second example mapping 520 of the three transmitters 504₁-504₃ to the Doppler domain spectrum 506 of the received frame of reflected chirps transmitted by the three transmitters 504₁-504₃ when implementing DDMA with a single empty band. According to the second mapping 520 of FIG. 5B, the first indexed transmitter 504₁ of the radar circuit is mapped to the second band 510 of the Doppler domain spectrum 506 and corresponds to the first representation 516_{A} of the object. In the example of FIG. 5B, the second indexed transmitter 504₂ of the radar circuit is mapped to the third band 512 of the Doppler domain spectrum 506 and corresponds to the second representation 516_{B} of the object.

In the illustrated example of FIG. 5B, the third indexed transmitter 504₃ of the radar circuit is mapped to the fourth band 514 of the Doppler domain spectrum 506 and corresponds to the third representation 516_{C} of the object. Also, the first band 508 of the Doppler domain spectrum 506 is mapped to the empty band 518. If the three transmitters 504₁-504₃ and the empty band 518 are mapped to the Doppler domain spectrum 506 according to the second mapping 520, then a radar circuit can determine that the velocity of the target is between negative V_{MAX}/2 and zero.

FIG. 5C is a diagram of a third example mapping 522 of the three transmitters 504₁-504₃ to the Doppler domain spectrum 506 of the received frame of reflected chirps transmitted by the three transmitters 504₁-504₃ when implementing DDMA with a single empty band. According to the third mapping 522 of FIG. 5C, the first indexed transmitter 504₁ of the radar circuit is mapped to the third band 512 of the Doppler domain spectrum 506 and corresponds to the first representation 516_{A} of the object. In the example of FIG. 5C, the second indexed transmitter 504₂ of the radar circuit is mapped to the fourth band 514 of the Doppler domain spectrum 506 and corresponds to the second representation 516_{B} of the object.

In the illustrated example of FIG. 5C, the third indexed transmitter 504₃ of the radar circuit is mapped to the first band 508 of the Doppler domain spectrum 506 and corresponds to the third representation 516_{C} of the object. Also, the second band 510 of the Doppler domain spectrum 506 is mapped to the empty band 518. If the three transmitters 504₁-504₃ and the empty band 518 are mapped to the Doppler domain spectrum 506 according to the third mapping 522, then a radar circuit can determine that the velocity of the target is between zero and V_{MAX}/2.

FIG. 5D is a diagram of a fourth example mapping 524 of the three transmitters 504₁-504₃ to the Doppler domain spectrum 506 of the received frame of reflected chirps transmitted by the three transmitters 504₁-504₃ when implementing DDMA with a single empty band. According to the fourth mapping 524 of FIG. 5D, the first indexed transmitter 504₁ of the radar circuit is mapped to the fourth band 514 of the Doppler domain spectrum 506 and corresponds to the first representation 516_{A} of the object. In the example of FIG. 5D, the second indexed transmitter 504₂ of the radar circuit is mapped to the first band 508 of the Doppler domain spectrum 506 and corresponds to the second representation 516_{B} of the object.

In the illustrated example of FIG. 5D, the third indexed transmitter 504₃ of the radar circuit is mapped to the second band 510 of the Doppler domain spectrum 506 and corresponds to the third representation 516_{C} of the object. Also, the third band 512 of the Doppler domain spectrum 506 is mapped to the empty band 518. If the three transmitters 504₁-504₃ and the empty band 518 are mapped to the Doppler domain spectrum 506 according to the fourth mapping 524, then a radar circuit can determine that the velocity of the target is between V_{MAX}/2 and V_{MAX}.

To perform DDMA disambiguation, a processor circuit (e.g., a radar backend) evaluates each of the potential mappings for a Doppler domain spectrum and determines which mapping results in the largest sum of energy in occupied bands according to the potential mappings. For example, for the first mapping 502 of FIG. 5A, a processor circuit sums the energy in the first band 508, the second band 510, and the third band 512 of the Doppler domain spectrum 506. Also, for the second mapping 520 of FIG. 5B, the processor circuit sums the energy in the second band 510, the third band 512, and the fourth band 514 of the Doppler domain spectrum 506.

For the third mapping 522 of FIG. 5C, the processor circuit sums the energy in the first band 508, the third band 512, and the fourth band 514 of the Doppler domain spectrum 506. Also, for the fourth mapping 524, the processor circuit sums the energy in the first band 508, the second band 510, and the fourth band 514 of the Doppler domain spectrum 506. To determine which mapping to apply to the Doppler domain spectrum 506, the processor circuit compares the sums determined for the first mapping 502, the second mapping 520, the third mapping 522, and the fourth mapping 524 and determines which mapping provides the largest sum. The processor circuit selects the mapping that provides the largest sum as the mapping for the Doppler domain spectrum 506.

In some examples, multiple contiguous empty bands can be included in a Doppler domain spectrum. For example, a Doppler domain spectrum for a radar circuit including four transmitters can include six bands (e.g., four bands corresponding to the four transmitters and two contiguous empty bands). Adding multiple contiguous empty bands can improve DDMA disambiguation and object detection under weak signal and/or weak target conditions. Also or alternatively, computational requirements to perform FFTs may require a Doppler domain spectrum to have a number of bins that corresponds to a power of two. As a result, the Doppler domain spectrum may include multiple contiguous empty bands.

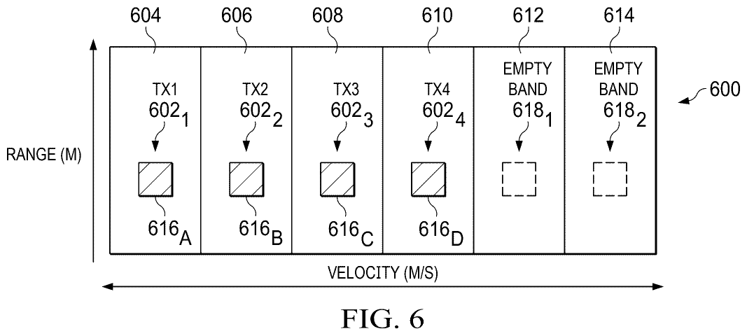

FIG. 6 is a diagram of an example Doppler domain spectrum 600 of a received frame of reflected chirps transmitted by four example transmitters 602₁-602₄ implementing DDMA with two contiguous empty bands and four contiguous occupied bands. In the example of FIG. 6, the Doppler domain spectrum 600 includes a first example band 604, a second example band 606, a third example band 608, a fourth example band 610, a fifth example band 612, and a sixth example band 614. Also, some of the bands of the Doppler domain spectrum 506 include a representation of an object that reflected chirps transmitted into an environment.

In the illustrated example of FIG. 6, the representation of the object in some of the bands corresponds to one of the transmitters that transmitted the chirps into the environment. In the Doppler domain spectrum 600 of FIG. 6, an example first indexed transmitter 602₁ of the radar circuit is mapped to the first band 604 of the Doppler domain spectrum 600 and corresponds to a first example representation 616_{A} of the object. In the example of FIG. 6, an example second indexed transmitter 602₂ of the radar circuit is mapped to the second band 606 of the Doppler domain spectrum 600 and corresponds to a second example representation 616_{B} of the object.

In the illustrated example of FIG. 6, an example third indexed transmitter 602₃ of the radar circuit is mapped to the third band 608 of the Doppler domain spectrum 600 and corresponds to a third example representation 616_{C} of the object. In the example of FIG. 6, an example fourth indexed transmitter 602₄ of the radar circuit is mapped to the fourth band 610 of the Doppler domain spectrum 600 and corresponds to a fourth example representation 616_{D} of the object. Also, the fifth band 612 of the Doppler domain spectrum 600 is mapped to a first example empty band 618₁ and the sixth band 614 of the Doppler domain spectrum 600 is mapped to a second example empty band 618₂.

Examples of DDMA with one or more contiguous empty bands are described in commonly assigned U.S. Patent Application Publication No. 2023/0072441, filed Sep. 3, 2021, entitled “Empty Band Doppler Division Multiple Access,” which is hereby incorporated herein by reference in its entirety. Also, example techniques to enable higher compression ratios in radar are described in commonly assigned U.S. Patent Application Publication No. 2024/0272275, filed Jul. 14, 2023, entitled “Technique to Enable Higher Compression Ratios in mmWave Radar,” which is hereby incorporated herein by reference in its entirety.

As illustrated in FIGS. 5A-5D and 6, adding one or more contiguous empty bands to a Doppler domain spectrum of a received frame of reflected chirps can improve the reliability of DDMA disambiguation. For example, adding one or more contiguous empty bands to a Doppler domain spectrum can improve the reliability of DDMA disambiguation with a high enough SNR (e.g., due to the absence of a representation of the target in the one or more contiguous empty bands). However, when there is a large amount of noise in a received frame of reflected chirps, a processor circuit may incorrectly perform DDMA disambiguation even with the presence of one or more contiguous empty bands.

Examples described herein include DDMA disambiguation with a non-uniform arrangement of two or more empty bands. By controlling transmitters of a radar circuit to transmit at phases determined to cause two or more non-contiguous empty bands to occur in Doppler domain spectrum, examples described herein improve the ability to perform DDMA disambiguation, for example, by sharpening the correlation function for object detection. For example, described examples optimally place two or more non-contiguous empty bands in a Doppler domain spectrum. Moreover, the techniques of this disclosure can be implemented in some examples without additional hardware for existing systems and/or without any increased latency and without using additional computational resources.

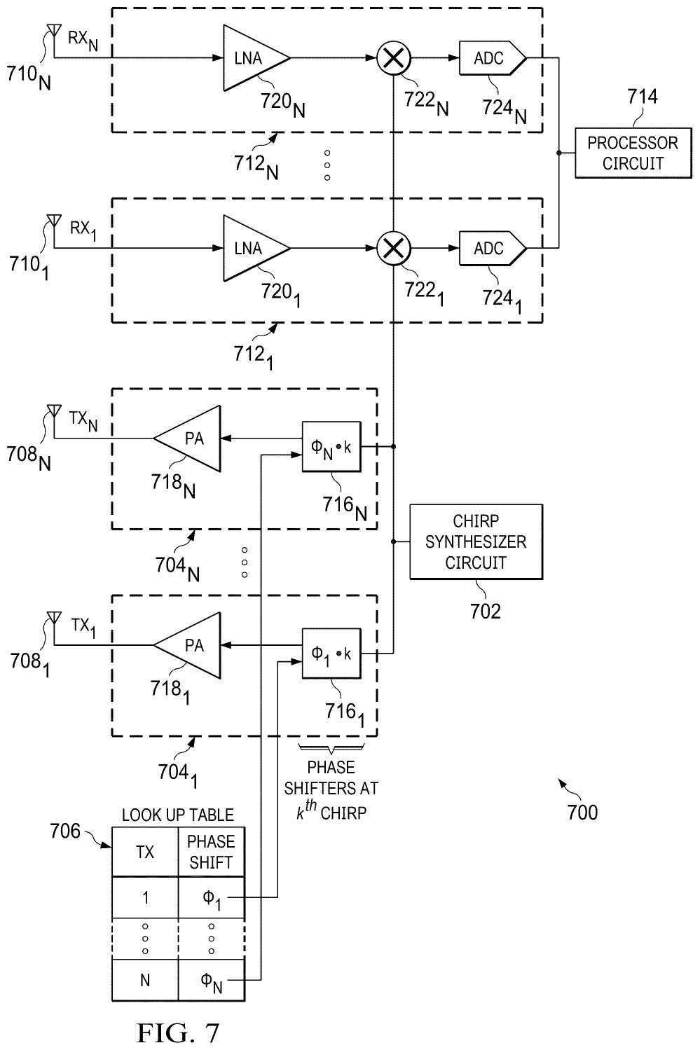

FIG. 7 is a block diagram of an example radar transceiver integrated circuit (IC) 700 that can implement any of the radar circuits 102_{A}, 102_{B}, 102_{C}, 102_{D}, 102_{E}, 102_{F}, 102_{G}, 102_{H} of FIG. 1. In the example of FIG. 7, the radar transceiver IC 700 includes an example chirp synthesizer circuit 702, example transmitters 704₁-704_{N}, an example lookup table (LUT) 706, example transmit antennas 708₁-708_{N}, example receive antennas 710₁-710_{N}, example receivers 712₁-712_{N}, and an example processor circuit 714. Also, in the example of FIG. 7, the transmitters 704₁-704_{N} include example phase shifters 716₁-716_{N} and example power amplifiers (PAs) 718₁-718_{N}, respectively.

In the illustrated example of FIG. 7, the receivers 712₁-712_{N} include example low noise amplifiers (LNAs) 720₁-720_{N}, example mixers 722₁-722_{N}, and example analog-to-digital converters (ADCs) 724₁-724_{N}, respectively. In the example of FIG. 7, the radar transceiver IC 700 includes four of each of the transmitters 704₁-704_{N}, the transmit antennas 708₁-708_{N}, the receive antennas 710₁-710_{N}, and the receivers 712₁-712_{N} (e.g., N equals four). In some examples, the radar transceiver IC 700 includes a different numbers of any of the transmitters 704₁-704_{N}, the transmit antennas 708₁-708_{N}, the receive antennas 710₁-710_{N}, or the receivers 712₁-712_{N}.

In some examples, the radar transceiver IC 700 and the processor circuit 714 are implemented separately and may be adapted to be coupled together. Also or alternatively, the radar transceiver IC 700 is implemented with the processor circuit 714, for example, in a single chip package or on a SoC (e.g., a single IC). In examples where the radar transceiver IC 700 is implemented with the processor circuit 714 on a SoC, the radar transceiver IC 700 may correspond to a sub-circuit of the IC that forms the SoC.

In the illustrated example of FIG. 7, the chirp synthesizer circuit 702 is implemented by at least one of analog or digital circuitry. In the example of FIG. 7, the chirp synthesizer circuit 702 is coupled to the transmitters 704₁-704_{N}. For example, the chirp synthesizer circuit 702 is coupled to the phase shifters 716₁-716_{N} of the transmitters 704₁-704_{N}. Also, in the example of FIG. 7, the chirp synthesizer circuit 702 is coupled to the receivers 712₁-712_{N}. For example, the chirp synthesizer circuit 702 is coupled to the mixers 722₁-722_{N} of the receivers 712₁-712_{N}. In some examples, the chirp synthesizer circuit 702 is coupled to the processor circuit 714.

In the illustrated example of FIG. 7, each of the phase shifters 716₁-716_{N} is implemented by at least one of analog or digital circuitry. In the example of FIG. 7, each of the phase shifters 716₁-716_{N} is coupled to the chirp synthesizer circuit 702 and the LUT 706. Also, in the example of FIG. 7, the phase shifters 716₁-716_{N} are coupled to the PAs 718₁-718_{N} (e.g., respective phase shifters are coupled to respective PAs). In the example of FIG. 7, each of the PAs 718₁-718_{N} is implemented by at least one of analog or digital circuitry. Also, in the example of FIG. 7, the PAs 718₁-718_{N} are coupled to the phase shifters 716₁-716_{N} and the transmit antennas 708₁-708_{N}.

In the illustrated example of FIG. 7, the LUT 706 is implemented by at least one of analog circuitry, digital circuitry, or memory. For example, the LUT 706 is implemented by a multiplexer and stored values where the multiplexer is coupled to the stored values. In such an example, the inputs to the multiplexer are coupled to the stored values and the select lines of the multiplexer are coupled to the phase shifters 716₁-716_{N}. In some examples, one or more of the values stored by the LUT 706 are hard-wired. Also or alternatively, one or more of the values stored by the LUT 706 are comprised in a data structure stored in memory such as read-only memory (ROM), erasable programmable ROM (EPROM), electrically erasable programmable ROM (EEPROM), or random-access memory (RAM) (e.g., static RAM (SRAM)).

In the illustrated example of FIG. 7, the LUT 706 stores phase changes Φ₁-Φ_{N} for the transmitters 704₁-704_{N}. In the example of FIG. 7, the phase changes Φ₁-Φ_{N} stored by the LUT 706 are based on simulation of various phase changes for the transmitters 704₁-704_{N} that introduce at least two non-contiguous empty bands in a Doppler spectrum representation of a received frame of reflected chirps. For example, simulation is performed to determine which combination of phase changes for the transmitters 704₁-704_{N} provides a threshold probability of successfully performing DDMA disambiguation, even in the presence of noise.

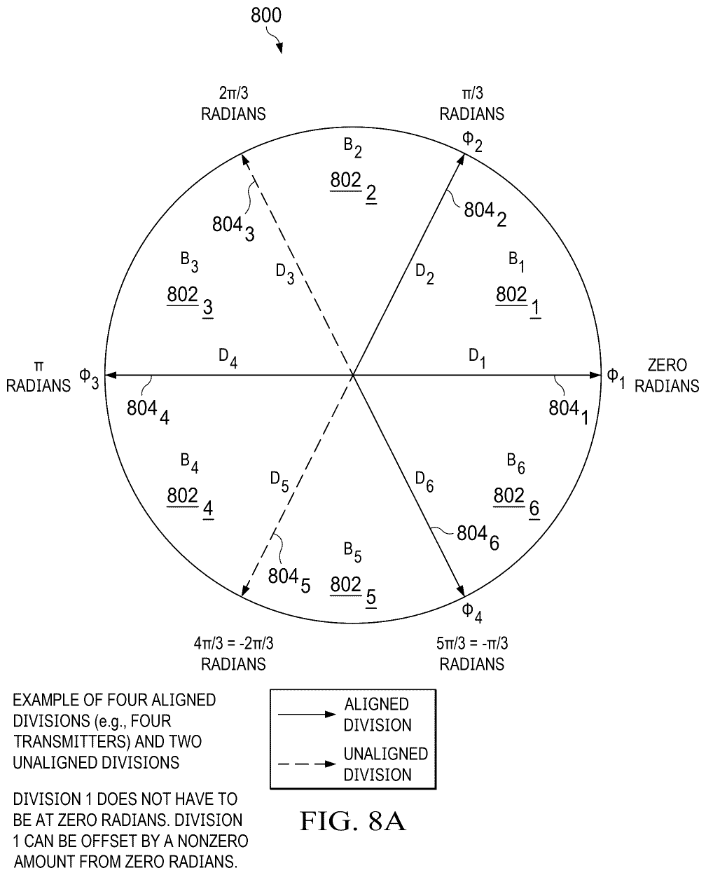

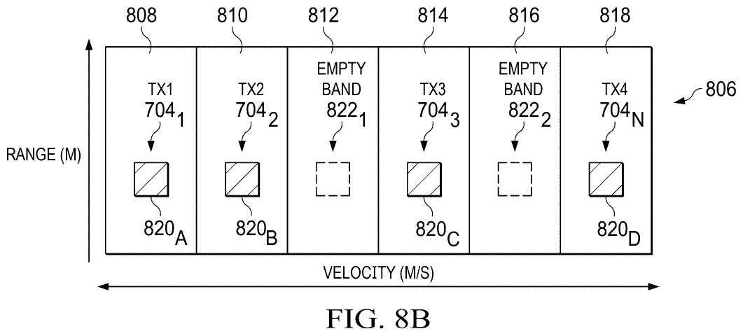

In the illustrated example of FIG. 7, the phase changes Φ₁-Φ_{N} determined via simulation do not increase linearly with a direct proportionality to transmitter indices. Instead, simulation results in the phase changes Φ₁-Φ_{N} for the transmitters 704₁-704_{N} that divide a phase spectrum for the transmitters 704₁-704_{N} into N_{B} bands where at least three of the phase changes are non-consecutively distributed along divisions of the phase spectrum (e.g., are not directly proportional to a corresponding transmitter index). FIG. 8A described further herein provides an example of a phase spectrum for the transmitters 704₁-704_{N} that has been divided into six bands with at least three of the phase changes being non-consecutively distributed along divisions of the phase spectrum.

In the illustrated example of FIG. 7, N_{B} is the number of bands in which a phase spectrum for the transmitters 704₁-704_{N} is to be divided and is equal to a sum of (1) the number of the transmitters 704₁-704_{N} (N_{TX}) and (2) a number of division of the phase spectrum along which none of the phase changes Φ₁-Φ_{N} are to be distributed (N_{EB}) (e.g., N_{B}=N_{TX}+N_{EB}). In some examples, simulation is performed by the processor circuit 714 offline (e.g., while the radar transceiver IC 700 is inactive). Also or alternatively, simulation is performed by a processor circuit external to the radar transceiver IC 700 (e.g., the processor circuit 714 in some examples, another processor circuit, etc.).

In the illustrated example of FIG. 7, the processor circuit 714 causes storage the phase changes Φ₁-Φ_{N} in the LUT 706. In some examples (e.g., where the processor circuit 714 performs simulation), the processor circuit 714 causes storage of the phase changes Φ₁-Φ_{N} in the LUT 706 after completion of the simulation. In additional or alternative examples (e.g., where a processor circuit external to the radar transceiver IC 700 performs simulation), the processor circuit 714 causes storage of the phase changes Φ₁-Φ_{N} in the LUT 706 based on receiving the phase changes Φ₁-Φ_{N}.

In the illustrated example of FIG. 7, the chirp synthesizer circuit 702 includes functionality to receive chirp parameter values (e.g., from the processor circuit 714) for a sequence of chirps in a radar frame. In some examples, the chirp parameters are defined by the radar system architecture and may include, for example, a transmitter enable parameter for indicating which of the transmitters 704₁-704_{N} to enable, a chirp frequency start value, a chirp frequency slope, an ADC sampling time, a ramp end time, and a transmitter start time, among others. In the example of FIG. 7, the chirp synthesizer circuit 702 also includes functionality to generate signals (e.g., a chirp, a frame of chirps, etc.) for transmission based on the chirp parameter values (e.g., received from the processor circuit 714). In some examples, the chirp synthesizer circuit 702 includes a phase locked loop (PLL) oscillator with a voltage-controlled oscillator (VCO). In additional or alternative examples, the chirp synthesizer circuit 702 includes a local oscillator (LO).

In the illustrated example of FIG. 7, each of the phase shifters 716₁-716_{N} receives the output signal provided by the chirp synthesizer circuit 702 (e.g., a chirp, a frame of chirps, etc.) and modulates the output signal provided by the chirp synthesizer circuit 702 based on data accessed from the LUT 706 to generate a frame of chirps having a linear phase change across chirps. For example, for an example first indexed transmitter 704₁, an example first indexed phase shifter 716₁ accesses a first phase change Φ₁ from the LUT 706 and applies the first phase change Φ₁ between consecutive chirps of a frame. As such, the first indexed phase shifter 716₁ generates a frame of chirps where the phase changes between consecutive chirps of the frame are equal (e.g., for TX₁ ΔΦ_{C1-C2}=ΔΦ_{C2-C3}=ΔΦ_{C3-C4} . . . =ΔΦ_{C(N-1)-CN)}. Also, for example, for an example Nth indexed transmitter 704_{N}, an example Nth indexed phase shifter 716_{N} accesses an Nth phase change Φ_{N} from the LUT 706 and applies the Nth phase change Φ_{N} between consecutive chirps of a frame. As such, the Nth indexed phase shifter 716_{N} generates a frame of chirps where the phase changes between consecutive chirps of the frame are equal (e.g., for T_{XN} ΔΦ_{C1-C2}=ΔΦ_{C2-C3}=ΔΦ_{C3-C4} . . . =ΔΦ_{C(N-1)-CN)}.

In the illustrated example of FIG. 7, the transmitters 704₁-704_{N} transmit frames of chirps simultaneously where each of the transmitters 704₁-704_{N} imparts a phase change (Φ) across the chirps of the frame as described above. For the k^{th} indexed transmitter, Φₖ=2π/N_{B}*L(k) where N_{B} the number of bands in which a phase spectrum for the transmitters 704₁-704_{N} is to be divided, L(k) is the value of the LUT 706 for the k^{th} indexed transmitter, and k is an index value in a range of [1:N] corresponding to a transmitter that will be transmitting a signal with a phase change (P. As described above, the phase changes Φ₁-Φ_{N} do not increase linearly with a directly proportionality to transmitter indices. In the example of FIG. 7, the phase changes Φ₁-Φ_{N} are based on simulation to determine, for a given number of transmitters and a number of divisions of a phase spectrum for the transmitters along which none of the phase changes Φ₁-Φ_{N} are to be distributed, the position (e.g., the optimal position) of at least two non-contiguous empty bands in a Doppler spectrum representation of a received frame of reflected chirps. As such, the difference in the phase changes applied by consecutively indexed phase shifters are not equal throughout the phase spectrum of the transmitters.

For example, FIG. 8A is a diagram of an example phase spectrum 800 of the transmitters 704₁-704_{N} of FIG. 7 when implementing DDMA with at least two non-contiguous empty bands. In the example of FIG. 8A, the number of the transmitters 704₁-704_{N} is four (e.g., N_{TX}=4) and the number of divisions of the phase spectrum 800 along which none of the phase changes Φ₁-Φ₄ are to be distributed is two (e.g., N_{EB}=2). Based on the programmed phase changes Φ₁-Φ₄, the phase spectrum 800 has been divided into six example bands 802₁-802₆ (e.g., B₁-B₆).

In the illustrated example of FIG. 8A, the phase spectrum 800 includes six example divisions 804₁-804₆ (e.g., D₁-D₆) at zero radians, π/3 radians, 2π/3 radians, π radians, 4π/3 or −2π/3 radians, and 5π/3 or −π/3 radians. In the example of FIG. 8A, the phase changes Φ₁-Φ₄ are aligned to the divisions 804₁-804_{N} according to Table 1 below. For example, Table 1 represents values stored in the LUT 706.

TABLE 1

| k | L(k) |
|---|---|
| 1 | 0 |
| 2 | 1 |
| 3 | 3 |
| 4 | 5 |

According to Table 1, the first indexed transmitter 704₁ is assigned a first phase change Φ₁ of zero radians, an example second indexed transmitter 704₂ is assigned a second phase change Φ₂ of π/3 radians, an example third indexed transmitter 704₃ is assigned a third phase change Φ₃ of π radians, and the Nth indexed transmitter 704_{N} (e.g., a fourth indexed transmitter) is assigned a fourth phase change Φ₄ of 5π/3 radians. As such, the respective phase changes D₁-Φ₄ are distributed along respective ones of the divisions 804₁-804₆ (e.g., D₁-D₆) of the phase spectrum 800. For example, the first phase change Φ₁ is aligned with a first example division 804₁ (e.g., D₁), the second phase change Φ₂ is aligned with a second example division 804₂ (e.g., D₂), a third example division 804₃ (e.g., D₃) is unaligned with any phase change, the third phase change Φ₃ is aligned with a fourth example division 804₄ (e.g., D₄), a fifth example division 804₅ (e.g., D₅) is unaligned with any phase change, and the fourth phase change Φ₄ is aligned with a sixth example division 804₆ (e.g., D₆).

As illustrated in FIG. 8A, at least three of the phase changes Φ₁-Φ₄ are not consecutively distributed along divisions of the phase spectrum 800 because phase change Φ₃ is not consecutive with phase change Φ₂ or phase change (4. In addition, the distribution of the unaligned divisions 804₃ and 804₅ is lopsided because the unaligned divisions 804₃ and 804₅ are not evenly distributed across the phase spectrum 800 (i.e., the third division 804₃ and the fifth division 804₅ are not separated by 180 degrees or π radians). As such, the difference in the phase changes Φ₁-Φ₄ applied by consecutively indexed phase shifters of the transmitters 704₁-704_{N} is not equal. For example, the difference in phase changes between the first phase change Φ₁ and the second phase change Φ₂ is π/3 (e.g., ΔΦ₁₋₂=π3), the difference in phase changes between the second phase change Φ₂ and the third phase change Φ₃ is 2π/3 (e.g., ΔΦ₂₋₃=2π/3), the difference in phase changes between the third phase change Φ₃ and the fourth phase change Φ₄ is 2π/3 (e.g., ΔΦ₃₋₄=2π/3), and the difference in phase changes between the fourth phase change Φ₄ and the first phase change Φ₁ is 5π/3 or π/3 (e.g., ΔΦ₄₋₁=5π/3).

As such, the difference in the phase changes applied by consecutively indexed phase shifters are not equal throughout the phase spectrum of the transmitters. For example, a first difference between the first phase change Φ₁ and the second phase change Φ₂ is different than a second difference between the second phase change Φ₂ and the third phase change Φ₃. In some examples, the first division 804₁ (e.g., D₁) may be positioned at another phase in the phase spectrum 800. For example, the first division 804₁ (e.g., D₁) may be offset by a nonzero amount from zero radians, and the other divisions may be offset by the same nonzero amount from their positions shown in FIG. 8A.

Returning to the example FIG. 7, each of the LNAs 720₁-720_{N} is implemented by at least one of analog or digital circuitry. In the example of FIG. 7, the LNAs 720₁-720_{N} are coupled to the mixers 722₁-722_{N} and the receive antennas 710₁-710_{N}. Also, each of the mixers 722₁-722_{N} is implemented by at least one of analog or digital circuitry. In the example of FIG. 7, the mixers 722₁-722_{N} are coupled to the chirp synthesizer circuit 702, the LNAs 720₁-720_{N}, and the ADCs 724₁-72₄N.

In the illustrated example of FIG. 7, each of the ADCs 724₁-724_{N} is implemented by at least one of analog or digital circuitry. In the example of FIG. 7, the ADCs 724₁-724_{N} are coupled to the mixers 722₁-722_{N} and the processor circuit 714. Also, the processor circuit 714 is implemented by at least one of analog or digital circuitry. For example, the processor circuit 714 may be implemented by a DSP, a microcontroller, an FFT engine, a combined DSP and microcontroller processor, an FPGA, or an application specific integrated circuit (ASIC). In the example of FIG. 7, the processor circuit 714 is coupled to the ADCs 724₁-724_{N}. In some examples, the processor circuit 714 is coupled to the chirp synthesizer circuit 702.

In the illustrated example of FIG. 7, each of the receive antennas 710₁-710_{N} receives signals reflected from an environment in a field of view of the radar transceiver IC 700. For example, each of the receive antennas 710₁-710_{N} receives frames of reflected chirps from the environment. Also, each of the LNAs 720₁-720_{N} amplifies the received frames of reflected chirps and forwards the amplified received frames to the mixers 722₁-722_{N}. In the example of FIG. 7, each of the mixers 722₁-722_{N} mixes the amplified received frames with the frame of chirps provided by the chirp synthesizer circuit 702 to produce IF received frames of reflected chirps. Also, each of the ADCs 724₁-724_{N} converts the IF received frames of reflected chirps from analog signals to digital signals.

In some examples, the radar transceiver IC 700 includes digital front end (DFE) circuitry between the ADCs 724₁-724_{N} and the processor circuit 714. For example, the DFE circuitry receives IF signals from the receivers 712₁-712_{N} and performs decimation filtering or other processing operations on the digital IF signals, for example, to reduce the data transfer rate of the digital IF signals. Also or alternatively, the DFE circuitry performs other operations on the digital IF signals such as direct current (DC) offset removal or compensation (e.g., digital compensation) of non-idealities in the receivers 712₁-712_{N} such as inter-receiver gain imbalance non-ideality, inter-receiver phase imbalance non-ideality, and the like.

In the illustrated example of FIG. 7, the processor circuit 714 is configured to perform at least a portion of signal processing on the digital IF signals resulting from a received radar frame. In some examples, the processor circuit 714 is configured to transmit the results of signal processing. For example, the processor circuit 714 transmits the results of signal processing to a processing unit (e.g., the processor circuit 104). In some examples, the processor circuit 714 interfaces with another device via a high-speed interface or an SPI. In the example of FIG. 7, the processor circuit 714 performs a range FFT on each received frame of reflected chirps. Also or alternatively, the processor circuit 714 performs a Doppler FFT on results of range FFTs. In some examples, the processor circuit 714 receives control information (e.g., timing of chirps, power level, triggering of monitoring functions, etc.) via an SPI. For example, based on the control information, the processor circuit 714 provides data parameters or provides control signals to the chirp synthesizer circuit 702.

FIG. 8B is a diagram of an example Doppler domain spectrum 806 of a received frame of reflected chirps transmitted by the transmitters 704₁-704_{N} of FIG. 7 when implementing DDMA with at least two non-contiguous empty bands. In the example of FIG. 8B, the Doppler domain spectrum 806 includes a first example band 808, a second example band 810, a third example band 812, a fourth example band 814, a fifth example band 816, and a sixth example band 818. Also, some of the bands of the Doppler domain spectrum 806 include a representation of an object that reflected chirps transmitted into an environment by the transmitters 704₁-704_{N} as described herein.

In the illustrated example of FIG. 8B, the representation of the object in some of the bands corresponds to one of the transmitters 704₁-704_{N} that transmitted the chirps into the environment. In the Doppler domain spectrum 806 of FIG. 8B, the first indexed transmitter 704₁ is mapped to the first band 808 of the Doppler domain spectrum 806 and corresponds to a first example representation 820_{A} of the object. In the example of FIG. 8B, the second indexed transmitter 704₂ is mapped to the second band 810 of the Doppler domain spectrum 806 and corresponds to a second example representation 820B of the object.

In the illustrated example of FIG. 8B, the third band 812 of the Doppler domain spectrum 806 is mapped to a first example empty band 822₁. In the example of FIG. 8B, the third indexed transmitter 704₃ is mapped to the fourth band 814 of the Doppler domain spectrum 806 and corresponds to a third example representation 820_{C} of the object. Also, in the example of FIG. 8B, the fifth band 816 of the Doppler domain spectrum 806 is mapped to a second example empty band 822₂. In the example of FIG. 8B, the Nth indexed transmitter 704_{N} (e.g., a fourth indexed transmitter) is mapped to the sixth band 818 of the Doppler domain spectrum 806 and corresponds to a fourth example representation 820D of the object.

As illustrated in FIG. 8B, the Doppler domain spectrum, 806 includes a plurality of bands where an object is represented in at least a portion of the plurality of the bands and at least three of the respective phase changes introduced by the phase shifters 716₁-716_{N} are non-consecutively distributed along the divisions of the phase spectrum. As such, the at least three of the respective phase changes introduced by the phase shifters 716₁-716_{N} being non-consecutively distributed along the divisions of the phase spectrum causes the Doppler domain spectrum 806 to include at least two non-contiguous bands in which the object is not represented (e.g., at least two non-contiguous empty bands). For example, the object is not represented in the third band 812, the fourth band 814 is contiguous with the third band 812 and the object is represented in the fourth band 814, and the fifth band 816 is contiguous with the fourth band 814 and the object is not represented in the fifth band 816.

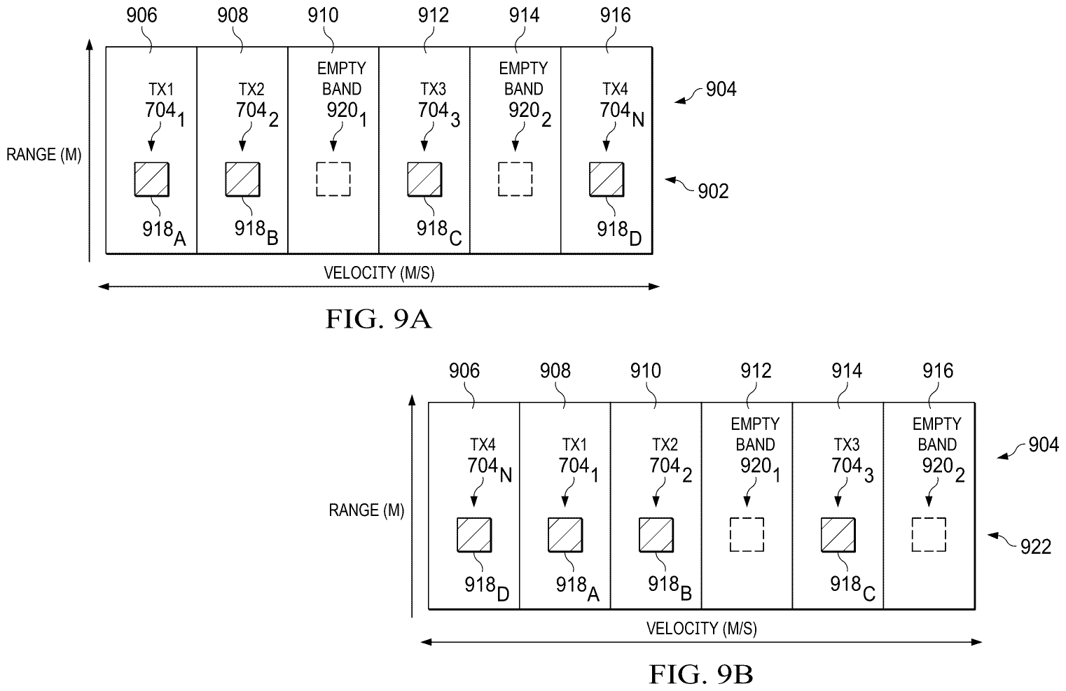

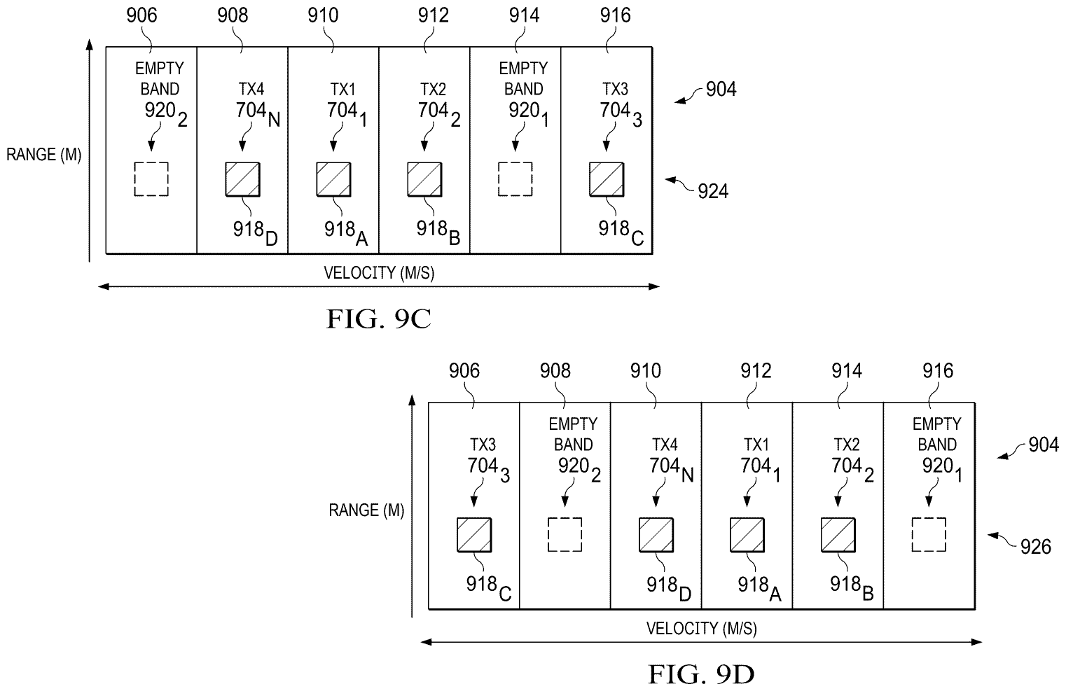

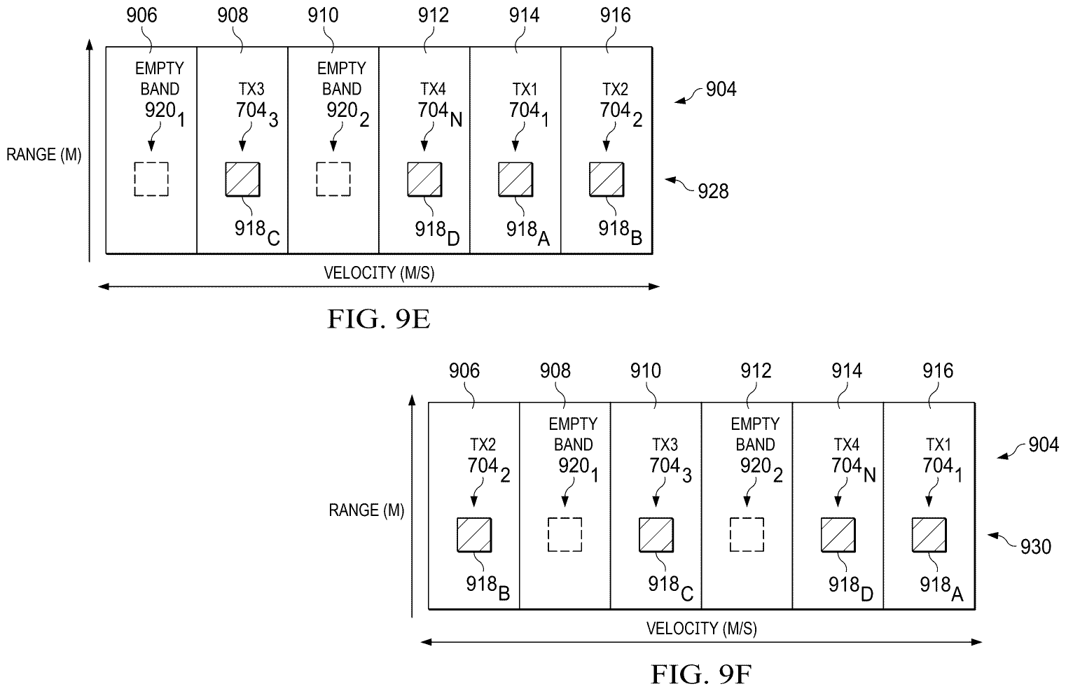

As described above, there are multiple potential mappings for a given number of transmitters and empty bands to a Doppler domain spectrum of a received frame of reflected chirps. FIG. 9A is a diagram of a first example mapping 902 of the transmitters 704₁-704_{N} of FIG. 7 to an example Doppler domain spectrum 904 of a received frame of reflected chirps transmitted by the transmitters 704₁-704_{N} of FIG. 7 when implementing DDMA with at least two non-contiguous empty bands. In the example of FIG. 9A, the Doppler domain spectrum 904 includes a first example band 906, a second example band 908, a third example band 910, a fourth example band 912, a fifth example band 914, and a sixth example band 916.

In the illustrated example of FIG. 9A, some of the bands of the Doppler domain spectrum 904 include a representation of an object that reflected chirps transmitted into an environment. In the example of FIG. 9A, the representation of the object in some of the bands corresponds to one of the transmitters 704₁-704_{N} that transmitted the chirps into the environment. According to the first mapping 902 of FIG. 9A, the first indexed transmitter 704₁ is mapped to the first band 906 of the Doppler domain spectrum 904 and corresponds to a first example representation 918_{A} of the object. In the example of FIG. 9A, the second indexed transmitter 704₂ is mapped to the second band 908 of the Doppler domain spectrum 904 and corresponds to a second example representation 918_{B} of the object.

In the illustrated example of FIG. 9A, the third band 910 of the Doppler domain spectrum 904 is mapped to a first example empty band 920₁. In the example of FIG. 9A, the third indexed transmitter 704₃ is mapped to the fourth band 912 of the Doppler domain spectrum 904 and corresponds to a third example representation 918_{C} of the object. Also, the fifth band 914 of the Doppler domain spectrum 904 is mapped to a second example empty band 920₂. In the example of FIG. 9A, the Nth indexed transmitter 704_{N} (e.g., a fourth indexed transmitter) is mapped to the sixth band 916 of the Doppler domain spectrum 904 and corresponds to a fourth example representation 918_{D} of the object. If the transmitters 704₁-704_{N}, the first empty band 920₁, and the second empty band 920₂ are mapped to the Doppler domain spectrum 904 according to the first mapping 902, then the processor circuit 714 can determine that the velocity of the target is between negative V_{MAX} and negative 2V_{MAX}/3.

FIG. 9B is a diagram of a second example mapping 922 of the transmitters 704₁-704_{N} of FIG. 7 to the Doppler domain spectrum 904 of a received frame of reflected chirps transmitted by the transmitters 704₁-704_{N} of FIG. 7 when implementing DDMA with at least two non-contiguous empty bands. According to the second mapping 922 of FIG. 9B, the first indexed transmitter 704₁ is mapped to the second band 908 of the Doppler domain spectrum 904 and corresponds to the first representation 918_{A} of the object. In the example of FIG. 9B, the second indexed transmitter 704₂ is mapped to the third band 910 of the Doppler domain spectrum 904 and corresponds to the second representation 918_{B} of the object.

In the illustrated example of FIG. 9B, the fourth band 912 is mapped to the first empty band 920₁. In the example of FIG. 9B, the third indexed transmitter 704₃ is mapped to the fifth band 914 of the Doppler domain spectrum 904 and corresponds to the third representation 918_{C} of the object. Also, the sixth band 916 of the Doppler domain spectrum 904 is mapped to the second empty band 920₂. In the example of FIG. 9B, the Nth indexed transmitter 704_{N} (e.g., a fourth indexed transmitter) is mapped to the first band 906 of the Doppler domain spectrum 904 and corresponds to the fourth representation 918_{D} of the object. If the transmitters 704₁-704_{N}, the first empty band 920₁, and the second empty band 920₂ are mapped to the Doppler domain spectrum 904 according to the second mapping 920, then the processor circuit 714 can determine that the velocity of the target is between negative 2V_{MAX}/3 and negative V_{MAX}/3.

FIG. 9C is a diagram of a third example mapping 924 of the transmitters 704₁-704_{N} of FIG. 7 to the Doppler domain spectrum 904 of a received frame of reflected chirps transmitted by the transmitters 704₁-704_{N} of FIG. 7 when implementing DDMA with at least two non-contiguous empty bands. According to the third mapping 924 of FIG. 9C, the first indexed transmitter 704₁ is mapped to the third band 910 of the Doppler domain spectrum 904 and corresponds to the first representation 918_{A} of the object. In the example of FIG. 9C, the second indexed transmitter 704₂ is mapped to the fourth band 912 of the Doppler domain spectrum 904 and corresponds to the second representation 918_{B} of the object.

In the illustrated example of FIG. 9C, the fifth band 914 is mapped to the first empty band 920₁. In the example of FIG. 9C, the third indexed transmitter 704₃ is mapped to the sixth band 916 of the Doppler domain spectrum 904 and corresponds to the third representation 918_{C} of the object. Also, the first band 906 of the Doppler domain spectrum 904 is mapped to the second empty band 920₂. In the example of FIG. 9C, the Nth indexed transmitter 704_{N} (e.g., a fourth indexed transmitter) is mapped to the second band 908 of the Doppler domain spectrum 904 and corresponds to the fourth representation 918_{D} of the object. If the transmitters 704₁-704_{N}, the first empty band 920₁, and the second empty band 920₂ are mapped to the Doppler domain spectrum 904 according to the third mapping 924, then the processor circuit 714 can determine that the velocity of the target is between negative V_{MAX}/3 and zero.

FIG. 9D is a diagram of a fourth example mapping 926 of the transmitters 704₁-704_{N} of FIG. 7 to the Doppler domain spectrum 904 of a received frame of reflected chirps transmitted by the transmitters 704₁-704_{N} of FIG. 7 when implementing DDMA with at least two non-contiguous empty bands. According to the fourth mapping 926 of FIG. 9D, the first indexed transmitter 704₁ is mapped to the fourth band 912 of the Doppler domain spectrum 904 and corresponds to the first representation 918_{A} of the object. In the example of FIG. 9D, the second indexed transmitter 704₂ is mapped to the fifth band 914 of the Doppler domain spectrum 904 and corresponds to the second representation 918_{B} of the object.

In the illustrated example of FIG. 9D, the sixth band 916 is mapped to the first empty band 920₁. In the example of FIG. 9D, the third indexed transmitter 704₃ is mapped to the first band 906 of the Doppler domain spectrum 904 and corresponds to the third representation 918_{C} of the object. Also, the second band 908 of the Doppler domain spectrum 904 is mapped to the second empty band 920₂. In the example of FIG. 9D, the Nth indexed transmitter 704_{N} (e.g., a fourth indexed transmitter) is mapped to the third band 910 of the Doppler domain spectrum 904 and corresponds to the fourth representation 918_{D} of the object. If the transmitters 704₁-704_{N}, the first empty band 920₁, and the second empty band 920₂ are mapped to the Doppler domain spectrum 904 according to the fourth mapping 926, then the processor circuit 714 can determine that the velocity of the target is between zero and V_{MAX}/3.

FIG. 9E is a diagram of a fifth example mapping 928 of the transmitters 704₁-704_{N} of FIG. 7 to the Doppler domain spectrum 904 of a received frame of reflected chirps transmitted by the transmitters 704₁-704_{N} of FIG. 7 when implementing DDMA with at least two non-contiguous empty bands. According to the fifth mapping 928 of FIG. 9E, the first indexed transmitter 704₁ is mapped to the fifth band 914 of the Doppler domain spectrum 904 and corresponds to the first representation 918_{A} of the object. In the example of FIG. 9E, the second indexed transmitter 704₂ is mapped to the sixth band 916 of the Doppler domain spectrum 904 and corresponds to the second representation 918_{B} of the object.

In the illustrated example of FIG. 9E, the first band 906 is mapped to the first empty band 920₁. In the example of FIG. 9E, the third indexed transmitter 704₃ is mapped to the second band 908 of the Doppler domain spectrum 904 and corresponds to the third representation 918_{C} of the object. Also, the third band 910 of the Doppler domain spectrum 904 is mapped to the second empty band 920₂. In the example of FIG. 9E, the Nth indexed transmitter 704_{N} (e.g., a fourth indexed transmitter) is mapped to the fourth band 912 of the Doppler domain spectrum 904 and corresponds to the fourth representation 918_{D} of the object. If the transmitters 704₁-704_{N}, the first empty band 920₁, and the second empty band 920₂ are mapped to the Doppler domain spectrum 904 according to the fifth mapping 928, then the processor circuit 714 can determine that the velocity of the target is between V_{MAX}/3 and 2V_{MAX}/3.

FIG. 9F is a diagram of a sixth example mapping 930 of the transmitters 704₁-704_{N} of FIG. 7 to the Doppler domain spectrum 904 of a received frame of reflected chirps transmitted by the transmitters 704₁-704_{N} of FIG. 7 when implementing DDMA with at least two non-contiguous empty bands. According to the sixth mapping 930 of FIG. 9F, the first indexed transmitter 704₁ is mapped to the sixth band 916 of the Doppler domain spectrum 904 and corresponds to the first representation 918_{A} of the object. In the example of FIG. 9F, the second indexed transmitter 704₂ is mapped to the first band 906 of the Doppler domain spectrum 904 and corresponds to the second representation 918_{B} of the object.

In the illustrated example of FIG. 9F, the second band 908 is mapped to the first empty band 920₁. In the example of FIG. 9F, the third indexed transmitter 704₃ is mapped to the third band 910 of the Doppler domain spectrum 904 and corresponds to the third representation 918_{C} of the object. Also, the fourth band 912 of the Doppler domain spectrum 904 is mapped to the second empty band 920₂. In the example of FIG. 9F, the Nth indexed transmitter 704_{N} (e.g., a fourth indexed transmitter) is mapped to the fifth band 914 of the Doppler domain spectrum 904 and corresponds to the fourth representation 918_{D} of the object. If the transmitters 704₁-704_{N}, the first empty band 920₁, and the second empty band 920₂ are mapped to the Doppler domain spectrum 904 according to the sixth mapping 930, then the processor circuit 714 can determine that the velocity of the target is between 2V_{MAX}/3 and V_{MAX}.

To perform DDMA disambiguation, the processor circuit 714 evaluates each of the potential mappings for a Doppler domain spectrum and determines which mapping results in the largest sum of energy in occupied bands according to the potential mappings. For example, for the first mapping 902 of FIG. 9A, the processor circuit 714 sums the energy in the first band 906, the second band 908, the fourth band 912, and the sixth band 916 of the Doppler domain spectrum 904. Also, for the second mapping 922 of FIG. 9B, the processor circuit 714 sums the energy in the second band 908, the third band 910, the fifth band 914, and the first band 906 of the Doppler domain spectrum 904.

For the third mapping 924 of FIG. 9C, the processor circuit 714 sums the energy in the third band 910, the fourth band 912, the sixth band 916, and the second band 908 of the Doppler domain Spectrum 904. Also, for the fourth mapping 926, the processor circuit 714 sums the energy in the fourth band 912, the fifth band 914, the first band 906, and the third band 910 of the Doppler domain spectrum 904. For the fifth mapping 928, the processor circuit 714 sums the energy in the fifth band 914, the sixth band 916, the second band 908, and the fourth band 912 of the Doppler domain Spectrum 904. Also, for the sixth mapping 930, the processor circuit 714 sums the energy in the sixth band 916, the first band 906, the third band 910, and the fifth band 914 and of the Doppler domain spectrum 904.

To determine which mapping to apply to the Doppler domain spectrum 904, the processor circuit 714 compares the sums determined for the first mapping 902, the second mapping 922, the third mapping 924, the fourth mapping 926, the fifth mapping 928, and the sixth mapping 930 and determines which mapping provides the largest sum. The processor circuit 714 selects the mapping that provides the largest sum as the mapping for the Doppler domain spectrum 904. In some examples, more than two non-contiguous empty bands can be included in a Doppler domain spectrum. For example, a Doppler domain spectrum for a radar circuit including four transmitters can include seven bands (e.g., four bands corresponding to the four transmitters and three empty bands where at least two are non-contiguous). Adding at least two non-contiguous empty bands can improve DDMA disambiguation under weak signal conditions as compared to DDMA with one more contiguous empty band.

Returning to the illustrated example of FIG. 7, the processor circuit 714 performs velocity disambiguation based on at least two non-contiguous empty bands as described herein. As such, the radar transceiver IC 700 may be referred to as a Doppler division multiple-access radar device. In some examples, the processor circuit 714 performs collision detection based on the at least two non-contiguous empty bands. As described above, a Doppler domain spectrum of a received frame of reflected chirps will include N_{B} bands where a target is represented in N_{TX} of the N_{B} bands (e.g., corresponding to reflected signals received from respective transmitters) and the Doppler domain spectrum includes N_{B}-N_{TX} empty bands (e.g., without any signal data).

The location of an empty band in a Doppler domain spectrum depends on the velocity of a target, as described above with reference to FIGS. 5A-5D and FIGS. 9A-9F. If there are multiple targets represented in the same Doppler domain spectrum of a received frame of reflected chirps, then the magnitude of the signals represented in each band of the Doppler domain spectrum will sum (e.g., add up). In such an example, if the multiple targets do not share the same mapping of transmitters and at least one empty band to the Doppler domain spectrum, then the at least one empty band corresponding to one target will be occupied by received signals from another target. Such an example is referred to as a collision. Collisions complicate disambiguation if undetected by the processor circuit 714.

In the illustrated example of FIG. 7, in the event of a collision, each spectrum band of the Doppler domain may be occupied, as described above due to a collision. In the example of FIG. 7, the processor circuit 714 can detect a collision based on the ratio of the largest value and the smallest value of the sums of energy computed during the disambiguation process. Responsive to the processor circuit 714 determining that a collision has occurred with respect to an object detected by the radar transceiver IC 700, the processor circuit 714 may ignore the collision-affected object and/or inform other processing components (e.g., the processor circuit 104), to ignore the collision-affected object.

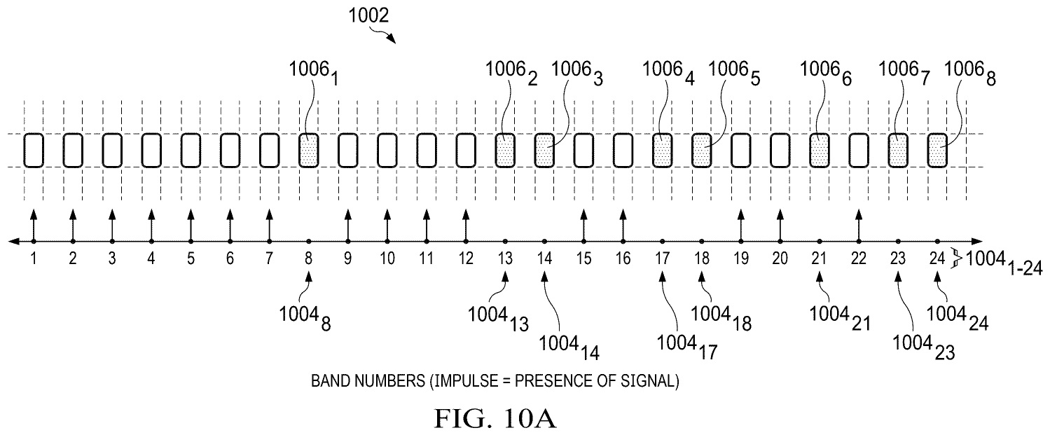

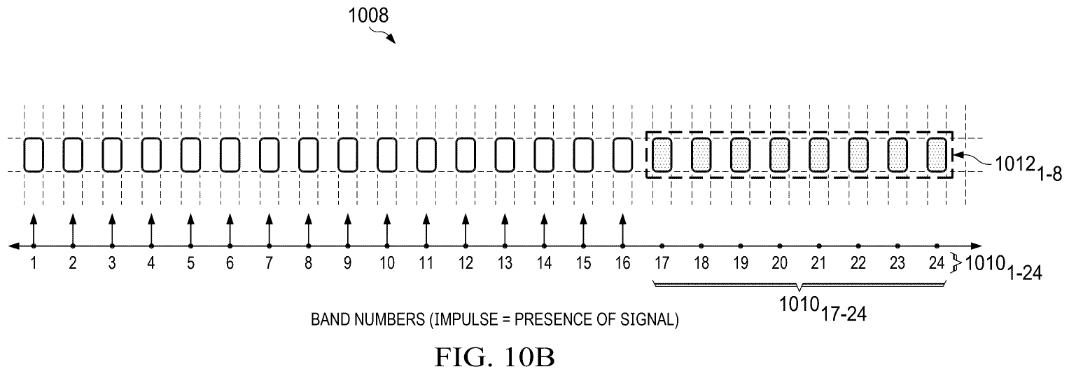

FIG. 10A is a diagram of an example Doppler domain spectrum 1002 of a received frame of reflected chirps transmitted by sixteen transmitters when implementing DDMA with eight non-contiguous empty bands. Due to the large number of transmitters shown in FIGS. 10A and 10B, these examples may be especially relevant for imaging radar. In the example of FIG. 10A, the Doppler domain spectrum 1002 is divided into 24 bands 1004₁-1004₂₄. In the Doppler domain spectrum 1002, an eighth example band 1004₈, a thirteenth example band 1004₁₃, a fourteenth example band 1004₁₄, a seventeenth example band 1004₁₇, an eighteenth example band 1004₁₈, a twenty-first example band 1004₂₁, a twenty-third example band 1004₂₃, and a twenty-fourth example band 1004₂₄ are mapped to a first example empty band 1006₁, a second example empty band 1006₂, a third example empty band 1006₃, a fourth example empty band 1006₄, a fifth example empty band 1006₅, a sixth example empty band 1006₆, a seventh example empty band 1006₇, and an eighth example empty band 1006₈, respectively.

FIG. 10B is a diagram of an example Doppler domain spectrum 1008 of a received frame of reflected chirps transmitted by sixteen transmitters when implementing DDMA with eight contiguous empty bands. In the example of FIG. 10B, the Doppler domain spectrum 1008 is divided into 24 bands 1010₁-1010₂₄. In the Doppler domain spectrum 1008, a seventeenth example band 1010₁₇, an eighteenth example band 1010₁₈, a nineteenth example band 1010₁₉, a twentieth example band 1010₂₀, a twenty-first example band 1010₂₁, a twenty-second example band 1010₂₂, a twenty-third example band 1010₂₃, and a twenty-fourth example band 1010₂₄ are mapped to a first example empty band 1012₁, a second example empty band 1012₂, a third example empty band 1012₃, a fourth example empty band 10124, a fifth example empty band 1012₅, a sixth example empty band 1012₆, a seventh example empty band 1012₇, and an eighth example empty band 1012₈, respectively.

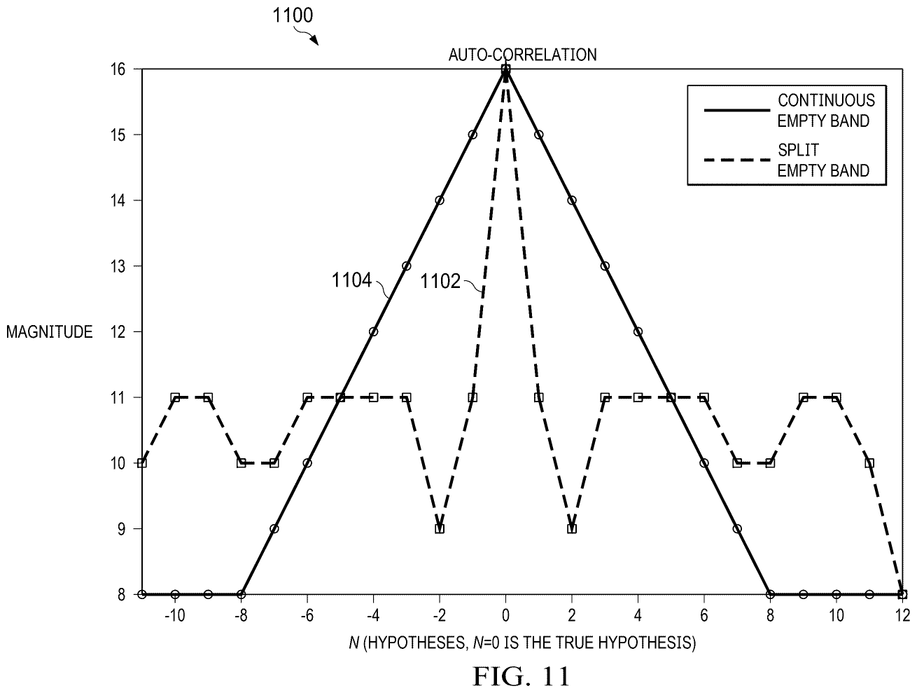

FIG. 11 is a diagram of an example graph 1100 illustrating auto-correlation of the Doppler domain spectrum 1002 of FIG. 10A and the Doppler domain spectrum 1008 of FIG. 10B to perform DDMA disambiguation. In the example of FIG. 11, the graph 1100 depicts magnitude of the sum of energy in occupied bands according to N potential mappings. In the example of FIG. 11, N ranges from negative eleven to twelve (e.g., there are twenty-four potential mappings).

In the illustrated example of FIG. 11, the graph 1100 includes a first example plot 1102 representative of the sums of energy in occupied bands according to the N potential mappings for the Doppler domain spectrum 1002. In the example of FIG. 11, the graph 1100 includes a second example plot 1104 representative of the sums of energy in occupied bands according to the N potential mappings for the Doppler domain spectrum 1008. In the example of FIG. 11, the potential mapping that provides the largest magnitude for the sum of energy in occupied bands is at N equals zero for the first plot 1102 and the second plot 1104. For example, the magnitude of the first plot 1102 and the second plot 1104 at N equals zero is sixteen.

As illustrated in FIG. 11, the next largest magnitude for a potential mapping is at N equals one and N equals negative one for the first plot 1102 and the second plot 1104. At N equals one and N equals negative one, the magnitude of the first plot 1102 is eleven. At N equals one and N equals negative one, the magnitude of the second plot 1104 is fifteen. As such, there is a greater distinction between the largest magnitude and the next largest magnitude provided by the potential mappings when implementing DDMA with eight non-contiguous empty bands (e.g., the first plot 1102) than when implementing DDMA with eight contiguous empty bands (e.g., the second plot 1104). Thus, there is a higher probability of correctly disambiguating antennas when implementing DDMA with non-contiguous empty bands than with contiguous empty bands.

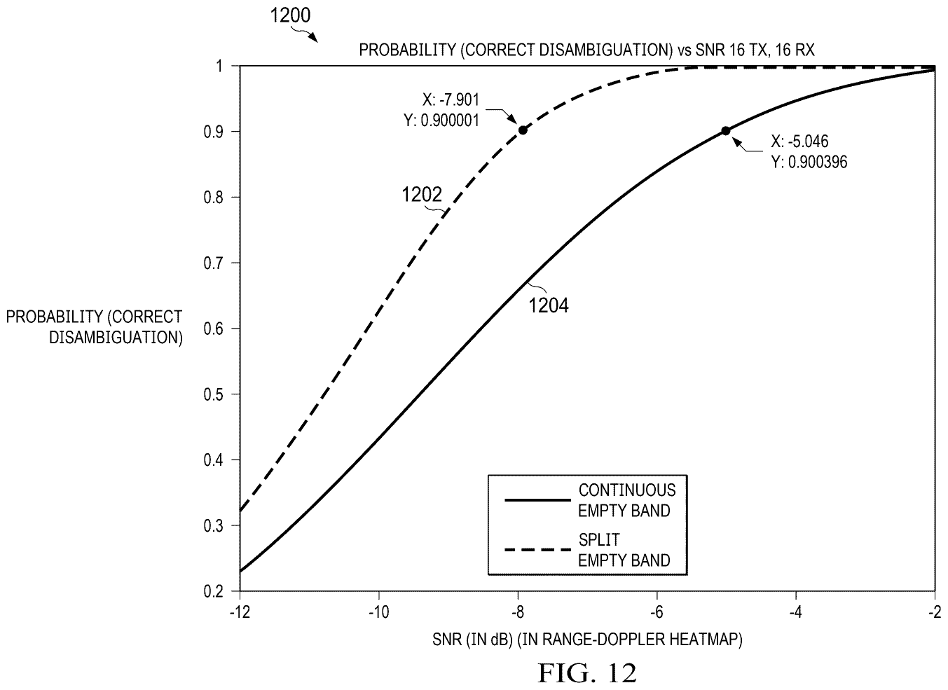

FIG. 12 is a diagram of an example graph 1200 illustrating the probability of correctly disambiguating sixteen transmitters with the Doppler domain spectrum 1002 of FIG. 10A and the Doppler domain spectrum 1008 of FIG. 10B with respect to SNR. In the example of FIG. 12, the graph 1200 depicts probability versus SNR. In the example of FIG. 12, the graph 1200 includes a first example plot 1202 representative of the probability of correctly disambiguating sixteen transmitters for the Doppler domain spectrum 1002. In the example of FIG. 12, the graph 1200 includes a second example plot 1204 representative of the probability of correctly disambiguating sixteen transmitters for the Doppler domain spectrum 1008.

In the illustrated example of FIG. 12, the first plot 1202 satisfies a threshold probability (e.g., 90% probability) of successfully performing disambiguation at −7.901 decibels (dB) on the SNR axis of the graph 1200. In the example of FIG. 12, the second plot 1204 satisfies the threshold probability of successfully performing disambiguation at −5.046 dB on the SNR axis of the graph 1200. As such, the range of successfully performing disambiguation is increased by about 3 dB when implementing DDMA with non-contiguous empty bands than with contiguous empty bands. Thus, disambiguation can be successfully performed in the presence of greater noise when implementing DDMA with non-contiguous empty bands than with contiguous empty bands.

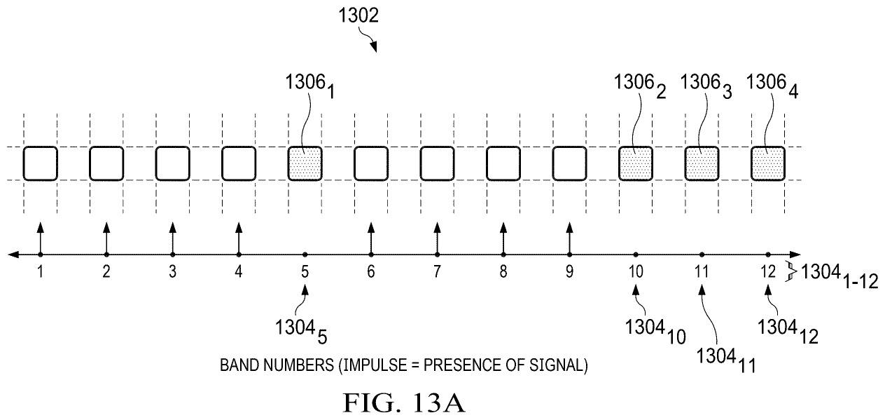

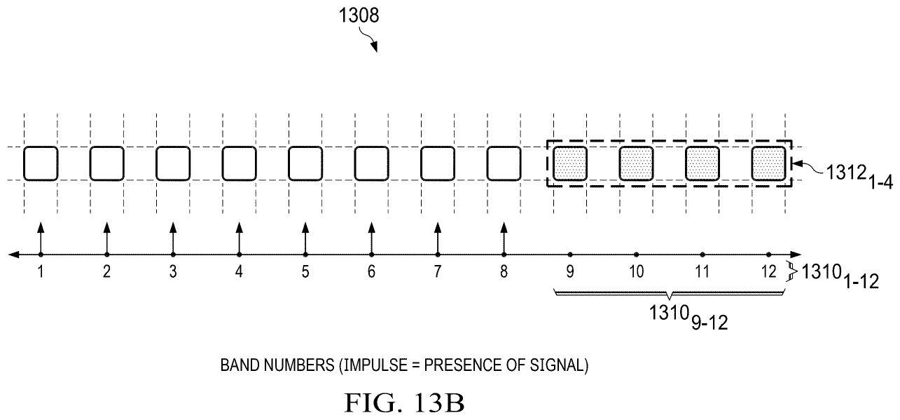

FIG. 13A is a diagram of an example Doppler domain spectrum 1302 of a received frame of reflected chirps transmitted by eight transmitters when implementing DDMA with four non-contiguous empty bands. In the example of FIG. 13A, the Doppler domain spectrum 1302 is divided into twelve bands 1304₁-1304₁₂. In the Doppler domain spectrum 1302, a fifth example band 1304₅, a tenth example band 1304₁₀, an eleventh example band 1304₁₁, and a twelfth example band 1304₁₂ are mapped to a first example empty band 1306₁, a second example empty band 1306₂, a third example empty band 1306₃, and a fourth example empty band 1306₄, respectively.

FIG. 13B is a diagram of an example Doppler domain spectrum 1308 of a received frame of reflected chirps transmitted by eight transmitters when implementing DDMA with four contiguous empty bands and eight contiguous occupied bands. In the example of FIG. 13B, the Doppler domain spectrum 1308 is divided into twelve bands 1310₁-1310₁₂. In the Doppler domain spectrum 1308, a ninth example band 1310₉, a tenth example band 1310₁₀, an eleventh example band 1310₁₁, and a twelfth example band 1310₁₂ are mapped to a first example empty band 13121, a second example empty band 1312₂, a third example empty band 1312₃, and a fourth example empty band 13124, respectively.

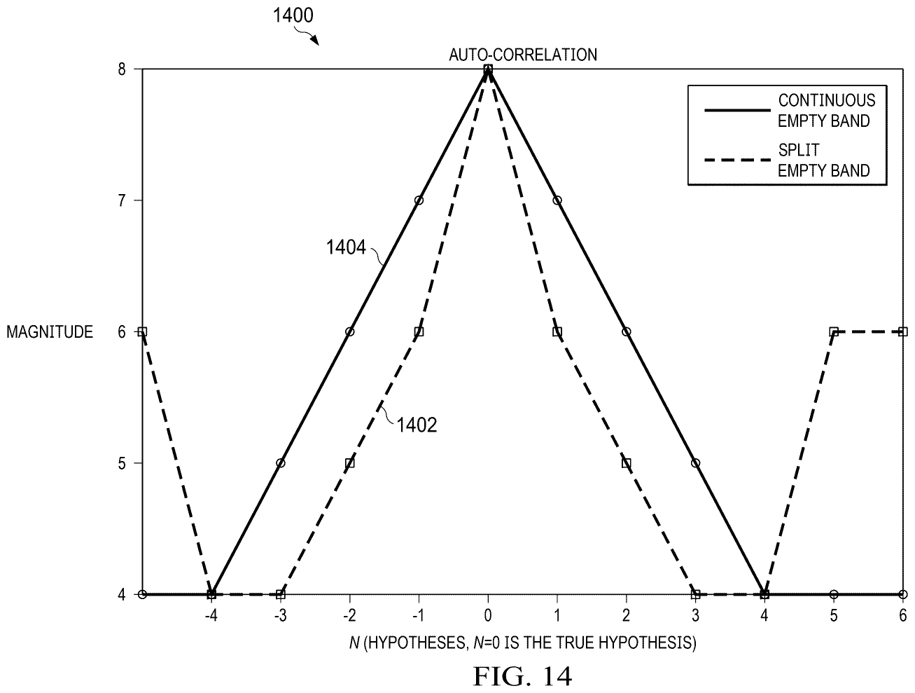

FIG. 14 is a diagram of an example graph 1400 illustrating auto-correlation of the Doppler domain spectrum 1302 of FIG. 13A and the Doppler domain spectrum 1308 of FIG. 13B to perform DDMA disambiguation. In the example of FIG. 14, the graph 1400 depicts magnitude of the sum of energy in occupied bands according to N potential mappings. In the example of FIG. 14, N ranges from negative five to six (e.g., there are twelve potential mappings).

In the illustrated example of FIG. 14, the graph 1400 includes a first example plot 1402 representative of the sums of energy in occupied bands according to the N potential mappings for the Doppler domain spectrum 1302. In the example of FIG. 14, the graph 1400 includes a second example plot 1404 representative of the sums of energy in occupied bands according to the N potential mappings for the Doppler domain spectrum 1308. In the example of FIG. 14, the potential mapping that provides the largest magnitude for the sum of energy in occupied bands is at N equals zero for the first plot 1402 and the second plot 1404. For example, the magnitude of the first plot 1402 and the second plot 1404 at N equals zero is eight.

As illustrated in FIG. 14, the next largest magnitude for a potential mapping is at N equals one and N equals negative one for the first plot 1402 and the second plot 1404. At N equals one and N equals negative one, the magnitude of the first plot 1402 is six. At N equals one and N equals negative one, the magnitude of the second plot 1404 is seven. As such, there is a greater distinction between the largest magnitude and the next largest magnitude provided by the potential mappings when implementing DDMA with four non-contiguous empty bands (e.g., the first plot 1402) than when implementing DDMA with four contiguous empty bands (e.g., the second plot 1404). Thus, there is a higher probability of correctly disambiguating antennas when implementing DDMA with non-contiguous empty bands than with contiguous empty bands.

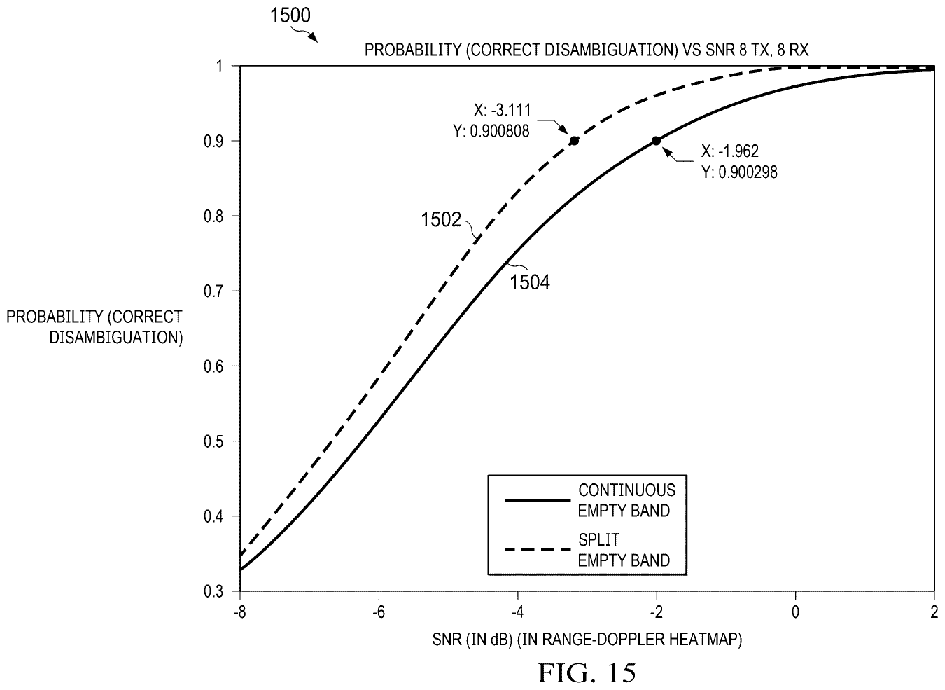

FIG. 15 is a diagram of an example graph 1500 illustrating the probability of correctly disambiguating eight transmitters with the Doppler domain spectrum 1302 of FIG. 13A and the Doppler domain spectrum 1308 of FIG. 13B with respect to SNR. In the example of FIG. 15, the graph 1500 depicts probability versus SNR. In the example of FIG. 15, the graph 1500 includes a first example plot 1502 representative of the probability of correctly disambiguating eight transmitters for the Doppler domain spectrum 1302. In the example of FIG. 15, the graph 1500 includes a second example plot 1504 representative of the probability of correctly disambiguating eight transmitters for the Doppler domain spectrum 1308.

In the illustrated example of FIG. 15, the first plot 1502 satisfies a threshold probability (e.g., 90% probability) of successfully performing disambiguation at −3.111 dB on the SNR axis of the graph 1500. In the example of FIG. 15, the second plot 1504 satisfies the threshold probability of successfully performing disambiguation at −1.962 dB on the SNR axis of the graph 1500. As such, the range of successfully performing disambiguation is increased by about 1 dB when implementing DDMA with non-contiguous empty bands than with contiguous empty bands. Thus, disambiguation can be successfully performed in the presence of greater noise when implementing DDMA with non-contiguous empty bands than with contiguous empty bands.

In some examples, the processor circuit 714 can adaptively change the number of empty bands to improve the probability of correctly disambiguating antennas when implementing DDMA. For example, a device with eight transmitters may implement DDMA with four non-contiguous empty bands resulting in a total of twelve bands (e.g. eight occupied bands and four non-contiguous empty bands as illustrated in FIG. 13A) in a Doppler domain spectrum of a received frame of reflected chirps. In a sparse environment, the processor circuit 714 can increase the number of empty bands from four to eight to result in sixteen total bands (e.g., eight occupied bands and eight empty bands) in a Doppler domain spectrum of a received frame of reflected chirps. For example, sparse environment refers to an environment with a smaller number of targets (e.g., less than a threshold number of targets).

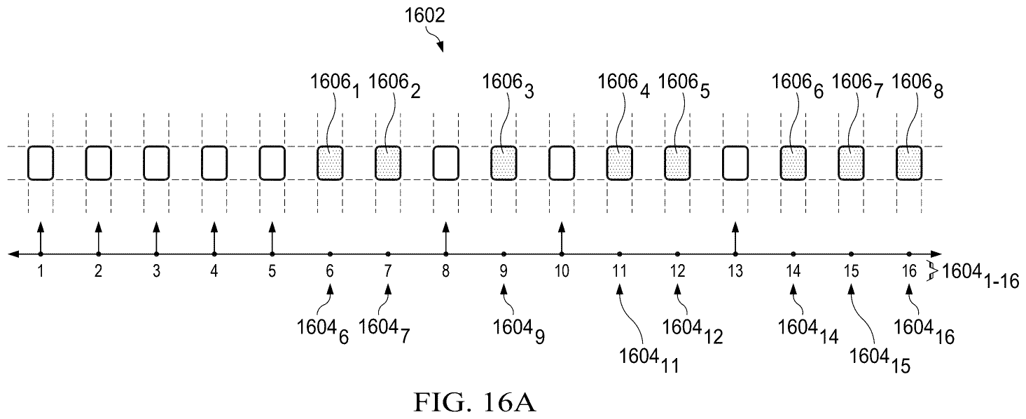

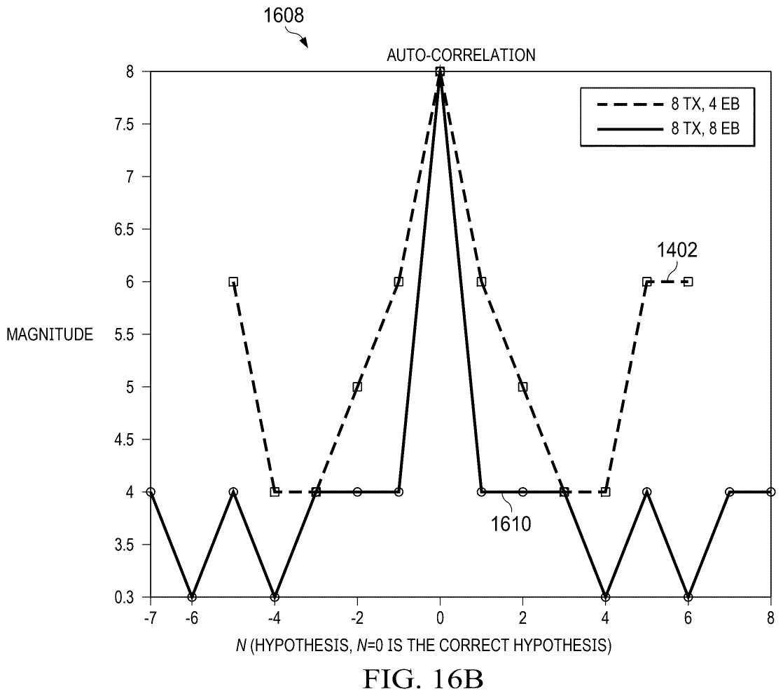

FIG. 16A is a diagram of an example Doppler domain spectrum 1602 of a received frame of reflected chirps transmitted by eight transmitters when implementing DDMA with eight non-contiguous empty bands. In the example of FIG. 16A, the Doppler domain spectrum 1602 is divided into sixteen bands 1604₁-1604₁₆. In the Doppler domain spectrum 1602, a sixth example band 1604₆, a seventh example band 1604₇, a ninth example band 1604₉, an eleventh example band 1604₁₁, a twelfth example band 1604₁₂, a fourteenth example band 1604₁₄, a fifteenth example band 1604₁₅, and a sixteenth example band 1604₁₆ are mapped to a first example empty band 1606₁, a second example empty band 1606₂, a third example empty band 1606₃, a fourth example empty band 1606₄, a fifth example empty band 1606₅, a sixth example empty band 1606₆, a seventh example empty band 1606₇, and an eighth example empty band 1606₈, respectively.

By increasing the number of non-contiguous empty bands, the processor circuit 714 causes auto-correlation of the Doppler domain spectrum 1602 of FIG. 16A to have a greater distinction between the largest magnitude and the next largest magnitude provided by potential mappings than auto-correlation of the Doppler domain spectrum 1302 of FIG. 13A. Consequently, by increasing the number of non-contiguous empty bands, the processor circuit 714 increases the probability of correctly disambiguating antennas.

For example, FIG. 16B is a diagram of an example graph illustrating auto-correlation of the Doppler domain spectrum 1302 of FIG. 13A and the Doppler domain spectrum 1602 of FIG. 16A to perform DDMA disambiguation. In the example of FIG. 16B, the graph 1608 depicts magnitude of the sum of energy in occupied bands according to N potential mappings. In the example of FIG. 16B, N ranges from negative seven to eight (e.g., there are sixteen potential mappings).

In the illustrated example of FIG. 16B, the graph 1608 includes the first plot 1402 which is representative of the sums of energy in occupied bands according to the twelve potential mappings for the Doppler domain spectrum 1302 shown in FIG. 14. In the example of FIG. 16B, the graph 1608 also includes a second example plot 1610 representative of the sums of energy in occupied bands according to the N potential mappings for the Doppler domain spectrum 1602 shown in FIG. 16B. In the example of FIG. 16B, the potential mapping that provides the largest magnitude for the sum of energy in occupied bands is at N equals zero for the first plot 1402 and the second plot 1610. For example, the magnitude of the first plot 1402 and the second plot 1610 at N equals zero is eight.

As illustrated in FIG. 16B, the next largest magnitude for a potential mapping is at N equals one and N equals negative one for the first plot 1402 and the second plot 1610. At N equals one and N equals negative one, the magnitude of the first plot 1402 is six. At N equals one and N equals negative one, the magnitude of the second plot 1610 is four. As such, there is a greater distinction between the largest magnitude and the next largest magnitude provided by the potential mappings when implementing DDMA with eight non-contiguous empty bands (e.g., the second plot 1610) than when implementing DDMA with four non-contiguous empty bands (e.g., the first plot 1402). Thus, there is a higher probability of correctly disambiguating antennas when implementing DDMA with eight non-contiguous empty bands than with four contiguous empty bands.

Increasing the number of empty bands can increase the probability of target collisions. As such, the processor circuit 714 determines whether an environment is sparse before increasing the number empty bands with which to implement DDMA. For example, the processor circuit 714 can determine sparsity of an environment based on at least one of a number of targets detected in a previous frame or a number of collisions detected in a previous frame. Once the processor circuit 714 has determined that an environment is sparse (e.g., that in a Doppler representation of a previous frame includes less than a threshold number of objects or targets), the processor circuit 714 can increase the number of empty bands with which to implement DDMA. For example, the processor circuit 714 can cause respective phase shifters of a plurality of transmitters of the radar transceiver IC 700 to adjust respective phase changes to cause a Doppler representation of a subsequent frame to include a larger number of empty bands. After increasing the number of empty bands with which to implement DDMA, the processor circuit 714 monitors the sparsity of the environment using at least one of a number of targets detected in a previous frame or a number of collisions detected in a previous frame. If the processor circuit 714 determines that the environment is no longer sparse, the processor circuit 714 can reduce the number of empty bands with which to implement DDMA to a default number (e.g., switch back to a default number of empty bands).

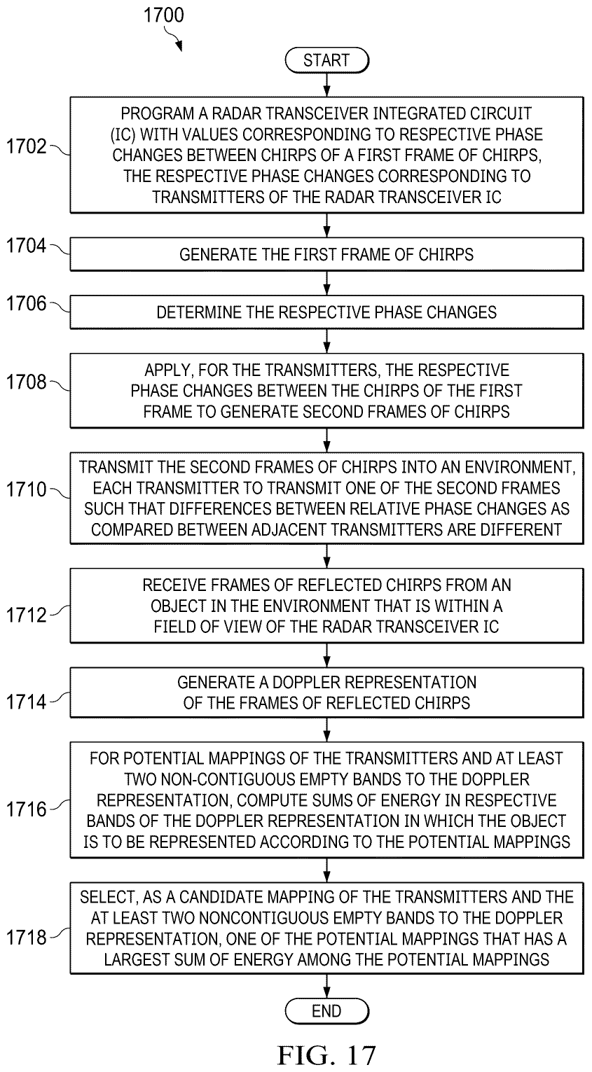

FIG. 17 is a flowchart representative of example machine-readable instructions or example operations 1700 that may be at least one of executed, instantiated, or performed using an example programmable circuitry implementation of the radar transceiver IC 700 of FIG. 7. The example machine-readable instructions and/or the example operations 1700 of FIG. 17 begin at block 1702, at which the processor circuit 714 programs the radar transceiver IC 700 with values corresponding to respective phase changes between chirps of a first frame of chirps. For example, the processor circuit 714 programs the LUT 706 of the radar transceiver IC 700. In the example of FIG. 7, the respective phase changes correspond to the transmitters 704₁-704_{N} of the radar transceiver IC 700.

In the illustrated example of FIG. 17, the programmed values are determined (e.g., by the processor circuit 714, another processor circuit, etc.) based on simulation of potential positions of at least two non-contiguous empty bands in a Doppler representation of second frames of reflected chirps from an object in a field of view of the radar transceiver IC 700. For N_{TX} transmitters and N_{B} bands in a phase spectrum for the N_{TX} transmitters (e.g., the number of empty bands N_{EB}=N_{B}−N_{TX}), the processor circuit 714 determines the phase changes for the N_{TX} transmitters by (1) searching through all possible mappings Pᵢ of the N_{TX} transmitters and at least two non-contiguous empty bands to the N_{B} bands of the phase spectrum and (2) simulating circular auto-correlation A_{P}_{ᵢ}(k) according to Equation 1 below. For example, Pᵢ(k)=1 if the kth band of the phase spectrum is mapped to a transmitter and zero otherwise, assuming Pᵢ(0)=1 for k∈[1, N_{B}−1].

$${A}_{{P}_{i}} ( k ) = {\sum }_{j = 0}^{{N}_{B} - 1} {P}_{i} ( j ) * {P}_{i} ( mod ( k + j , {N}_{B} ) ) \qquad Equation 1$$

In the illustrated example of FIG. 17, based on simulating circular auto-correlation A_{P}_{ᵢ₍ₖ₎} according to Equation 1, the processor circuit 714 selects the possible mapping Pᵢ(k) that provides the greatest distinction or difference between the largest magnitude and the next largest magnitude provided by the potential mappings. Based on the selected mapping, the processor circuit 714 determines the phase changes that correspond to the transmitters 704₁-704_{N} of the radar transceiver IC 700 to achieve the selected mapping of bands of the phase spectrum of the transmitters 704₁-704_{N} to the transmitters 704₁-704_{N} and at least two non-contiguous empty bands. Additionally or alternatively, the mapping may be configurable by a user.

In the illustrated example of FIG. 17, the radar transceiver IC 700 performs DDMA disambiguation with at least two non-contiguous empty bands. For example, the radar transceiver IC 700 performs DDMA disambiguation with at least two non-contiguous empty bands for every frame of chirps transmitted by the transmitters 704₁-704_{N} (e.g., every 50 milliseconds, at a frequency of 20 Hertz). In the example of FIG. 17, at block 1704, the chirp synthesizer circuit 702 generates the first frame of chirps. In the example of FIG. 17, at block 1706, the phase shifters 716₁-716_{N} determine the respective phase changes for the transmitters 704₁-704_{N}. For example, the phase shifters 716₁-716_{N} access the LUT 706 to determine the respective phase changes for the transmitters 704₁-704_{N}. In the example of FIG. 17, at block 1708, the phase shifters 716₁-716_{N} apply, for the transmitters 704₁-704_{N}, the respective phase changes between the chirps of the first frame to generate second frames of chirps.

In the illustrated example of FIG. 17, at block 1710, the transmitters 704₁-704_{N} transmit the second frames of chirps into an environment. For example, the PAs 718₁-718_{N} amplify the second frames and transmit the second frames of chirps into the environment via the transmit antennas 708₁-708_{N}. In the example of FIG. 17, each of the transmitters 704₁-704_{N} transmits one of the second frames such that the differences between relative phase changes as compared between adjacent transmitters are different. For example, each of the transmitters 704₁-704_{N} transmits the respective frames of chirps having the respective phase changes programmed into the LUT 706.

In the illustrated example of FIG. 17, at block 1712, the receivers 712₁-712_{N} receive frames of reflected chirps from an object in the environment that is within a field of view of the radar transceiver IC 700. In the example of FIG. 17, at block 1714, the processor circuit 714 generates a Doppler representation of the frames of reflected chirps. For example, the processor circuit 714 generates a Doppler representation for the frames of reflected chirps received at each of the receive antennas 710₁-710_{N}. In the example of FIG. 17, the processor circuit 714 collapses the Doppler representations for each of the receivers 712₁-712_{N} across the receive antennas 710₁-710_{N} to generate a single Doppler representation.

In the illustrated example of FIG. 17, at block 1716, for potential mappings of the transmitters 704₁-704_{N} and at least two non-contiguous empty bands to the Doppler representation, the processor circuit 714 computes sums of energy in respective bands of the Doppler representation in which the object is to be represented according to the potential mappings. In the example of FIG. 17, at block 1718, the processor circuit 714 selects, as a candidate mapping of the transmitters 704₁-704_{N} and the at least two non-contiguous empty bands to the Doppler representation, one of the potential mappings that has a largest sum of energy among the potential mappings. Based on the candidate mapping, the processor circuit 714 can disambiguate the transmit antennas 708₁-708_{N} and determine a velocity of the object detected in the environment.

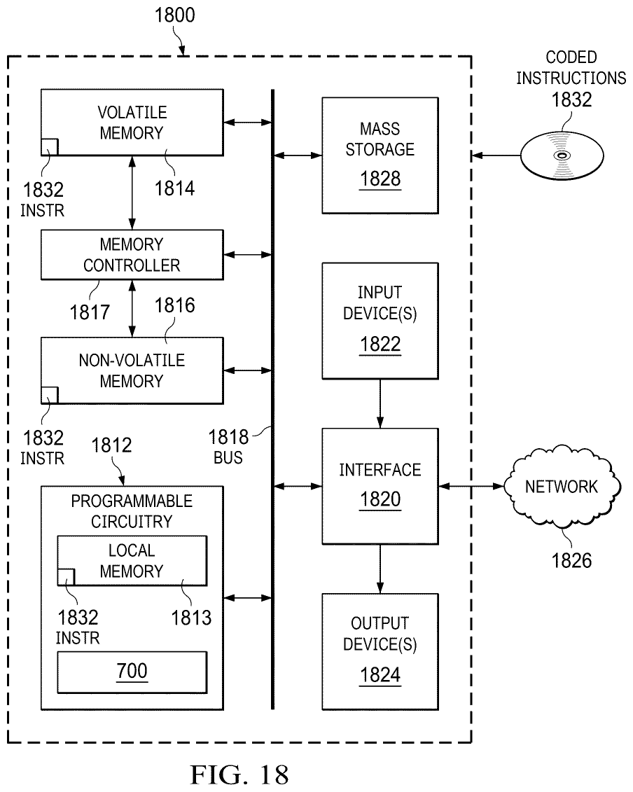

FIG. 18 is a block diagram of an example programmable circuitry platform 1800 structured to one or a combination of execute or instantiate one or more of the example machine-readable instructions or the example operations of FIG. 17 to implement the radar transceiver IC 700 of FIG. 7. The programmable circuitry platform 1800 can be, for example, a server, a personal computer, a workstation, a self-learning machine (e.g., a neural network), a mobile device (e.g., a cell phone, a smart phone, a tablet such as an iPad™), apersonal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing or electronic device.

The programmable circuitry platform 1800 of the illustrated example includes programmable circuitry 1812. The programmable circuitry 1812 of the illustrated example is hardware. For example, the programmable circuitry 1812 can be implemented by one or more integrated circuits, logic circuits, FPGAs, microprocessors, CPUs, GPUs, DSPs, or microcontrollers from any desired family or manufacturer. The programmable circuitry 1812 may be implemented by one or more semiconductor based (e.g., silicon based) devices. In this example, the programmable circuitry 1812 implements the radar transceiver IC 700 of FIG. 7.

The programmable circuitry 1812 of the illustrated example includes a local memory 1813 (e.g., a cache, registers, etc.). The programmable circuitry 1812 of the illustrated example is in communication with main memory 1814, 1816, which includes a volatile memory 1814 and a non-volatile memory 1816, by a bus 1818. The volatile memory 1814 may be implemented by one or more Synchronous Dynamic Random Access Memory (SDRAM), Dynamic Random Access Memory (DRAM), RAMBUS® Dynamic Random Access Memory (RDRAM®), or any other type of RAM device. The non-volatile memory 1816 may be implemented by one or a combination of flash memory or any other desired type of memory device. Access to the main memory 1814, 1816of the illustrated example is controlled by a memory controller 1817. In some examples, the memory controller 1817 may be implemented by one or more integrated circuits, logic circuits, microcontrollers from any desired family or manufacturer, or any other type of circuitry to manage the flow of data going to and from the main memory 1814, 1816.

The programmable circuitry platform 1800 of the illustrated example also includes interface circuitry 1820. The interface circuitry 1820 may be implemented by hardware in according to any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 1822 are connected to the interface circuitry 1820. The input device(s) 1822 permit(s) a user (e.g., a human user, a machine user, etc.) to enter one of or a combination of data or commands into the programmable circuitry 1812. The input device(s) 1822 can be implemented by, for example, one of or a combination of an audio sensor, a microphone, a camera (still or video), a keyboard, a button, a mouse, a touchscreen, a trackpad, a trackball, an isopoint device, or a voice recognition system.

One or more output devices 1824 are also connected to the interface circuitry 1820 of the illustrated example. The output device(s) 1824 can be implemented, for example, by one of or a combination of display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, or speaker. The interface circuitry 1820 of the illustrated example, thus, includes one of or a combination of a graphics driver card, a graphics driver chip, or graphics processor circuitry such as a GPU.

The interface circuitry 1820 of the illustrated example also includes a communication device such as one of or a combination of a transmitter, a receiver, a transceiver, a modem, a residential gateway, a wireless access point, or a network interface to facilitate exchange of data with external machines (e.g., computing devices of any kind) by a network 1826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1800 of the illustrated example also includes one or more mass storage discs or devices 1828 to store one or more of firmware, software, or data. Examples of such mass storage discs or devices 1828 include one or more magnetic storage devices (e.g., floppy disk, drives, HDDs, etc.), optical storage devices (e.g., Blu-ray disks, CDs, DVDs, etc.), RAID systems, or solid-state storage discs or devices such as flash memory devices and SSDs.

The machine-readable instructions 1832, which may be implemented by the machine-readable instructions of FIG. 17, may be stored in one of or a combination of the mass storage device 1828, in the volatile memory 1814, in the non-volatile memory 1816, or on at least one non-transitory computer-readable storage medium such as a CD or DVD which may be removable.

While an example manner of implementing one or more of the radar circuits 102_{A}, 102_{B}, 102_{C}, 102_{D}, 102_{E}, 102_{F}, 102_{G}, 102_{H} of FIG. 1 is illustrated in FIG. 7, one or more of the elements, processes, or devices illustrated in FIG. 7 may be combined, divided, re-arranged, omitted, eliminated, or implemented in any other way. Further, the example chirp synthesizer circuit 702, the example transmitters 704₁-704_{N}, the example LUT 706, the example transmit antennas 708₁-708_{N}, the example receive antennas 710₁-710_{N}, the example receivers 712₁-712_{N}, the example processor circuit 714, the example phase shifters 716₁-716_{N}, the example PAs 718₁-718_{N}, the example LNAs 720₁-720_{N}, the example mixers 722₁-722_{N}, the example ADCs 724₁-724_{N}, or, more generally, the example radar transceiver IC 700 of FIG. 7, may be implemented by hardware alone or by hardware in combination with software and firmware.

Thus, for example, any of the example chirp synthesizer circuit 702, the example transmitters 704₁-704_{N}, the example LUT 706, the example transmit antennas 708₁-708_{N}, the example receive antennas 710₁-710_{N}, the example receivers 712₁-712_{N}, the example processor circuit 714, the example phase shifters 716₁-716_{N}, the example PAs 718₁-718_{N}, the example LNAs 720₁-720_{N}, the example mixers 722₁-722_{N}, the example ADCs 724₁-724_{N}, or, more generally, the example radar transceiver IC 700, could be implemented by programmable circuitry in combination with one or more machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example radar transceiver IC 700 of FIG. 7 may include one or more elements, processes, or devices in addition to, or instead of, those illustrated in FIG. 7, or may include more than one of any or all of the illustrated elements, processes and devices.

A flowchart representative of example machine-readable instructions, which may be executed by programmable circuitry to at least one of implement or instantiate the radar transceiver IC 700 of FIG. 7 or representative of example operations which may be performed by programmable circuitry to at least one of implement or instantiate the radar transceiver IC 700 of FIG. 7, are shown in FIG. 17. The machine-readable instructions may be one or more executable programs or portion(s) of one or more executable programs for execution by programmable circuitry such as the programmable circuitry 1812 shown in the example programmable circuitry platform 1800 described below in connection with FIG. 18 and may be one or more function(s) or portion(s) of functions to be performed by the example programmable circuitry (e.g., an FPGA). In some examples, the machine-readable instructions cause an operation, a task, etc., to be carried out or performed in an automated manner in the real-world. As used herein, “automated” means without human involvement.

The program may be embodied in instructions (e.g., software and/or firmware) stored on one or more non-transitory computer-readable and/or machine-readable storage medium such as one of or a combination of cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), or any other storage device or storage disk. The instructions of the non-transitory computer-readable and/or machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIG. 17, many other methods of implementing the example radar transceiver IC 700 may alternatively be used. For example, the order of execution of the blocks of the flowchart(s) may be changed, or some of the blocks described may be changed, eliminated, or combined. Also or alternatively, any or all of the blocks of the flow chart may be implemented by one or more hardware circuits (e.g., processor circuitry, discrete, integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (e.g., a single-core processor (e.g., a single core CPU), a multi-core processor (e.g., a multi-core CPU, an XPU, etc.)). For example, the programmable circuitry may be one of or a combination of a CPU or an FPGA located in the same package (e.g., the same integrated circuit (IC) package or in two or more separate housings), one or more processors in a single machine, multiple processors distributed across multiple servers of a server rack, multiple processors distributed across one or more server racks, etc., or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine-executable instructions. For example, the machine-readable instructions may be fragmented and stored on one or more storage devices, disks or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to render them directly readable, interpretable, or executable by a computing device or other machine. For example, the machine-readable instructions may be stored in multiple parts, which are individually compressed, encrypted, or stored on separate computing devices, where the parts when decrypted, decompressed, or combined form a set of one or more computer-executable or machine-executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data provided, network addresses recorded, etc.) before the machine-readable instructions or the corresponding program(s) can be executed in whole or in part. Thus, machine-readable, computer-readable or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C-sharp, Perl, Python, JavaScript, HyperText Markup Language (HTML), Structured Query Language (SQL), Swift, etc.

As mentioned above, the example operations of FIG. 17 may be implemented using executable instructions (e.g., computer-readable and/or machine-readable instructions) stored on one or more non-transitory computer-readable or machine-readable media. As used herein, the terms non-transitory computer-readable medium, non-transitory computer-readable storage medium, non-transitory machine-readable medium, and non-transitory machine-readable storage medium are expressly defined to include any type of computer-readable storage device or storage disk and to exclude propagating signals and to exclude transmission media.

Examples of such non-transitory computer-readable medium, non-transitory computer-readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information). As used herein, the terms “non-transitory computer-readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer-readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer-readable instructions, machine-readable instructions, etc., or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and things, the phrase “at least one of A and B” refers to implementations including any of (1) at least one A, (2) at least one B, or (3) at least one A and at least one B. Similarly, as used herein in the context of describing structures, components, items, objects and things, the phrase “at least one of A or B” refers to implementations including any of (1) at least one A, (2) at least one B, or (3) at least one A and at least one B.

As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is at least one of not feasible or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used herein, connection references (e.g., attached, coupled, connected, and joined) may include intermediate members between the elements referenced by at least one of the connection reference or relative movement between those elements unless otherwise indicated. As such, connection references do not necessarily infer that two elements are directly connected or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, or ordering in any way, but are merely used as at least one of labels or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the description (e.g., within a claim) in which the elements might, for example, otherwise share a same name.

As used herein, the phrase “in communication,” including variations thereof, encompasses one of or a combination of direct communication or indirect communication through one or more intermediary components, and does not require direct physical (e.g., wired) communication or constant communication, but rather also includes selective communication at least one of periodic intervals, scheduled intervals, aperiodic intervals, or one-time events.

As used herein, “programmable circuitry” is defined to include at least one of (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., at least one of programmed or hardwired) at a time of manufacturing by a manufacturer to at least one of perform the function or be configurable (or re-configurable) by a user after manufacturing to perform the function/or other additional or alternative functions. The configuring may be through at least one of firmware or software programming of the device, through at least one of a construction or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as voltage and/or current sources) may instead include only the semiconductor elements within a single physical device (e.g., at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Uses of the phrase “ground” in the foregoing description include at least one of a chassis ground, an Earth ground, a floating ground, a virtual ground, a digital ground, a common ground, or any other form of ground connection applicable to, or suitable for, the teachings of this description. As used herein, “approximately” and “about” modify their subjects/values to recognize the potential presence of variations that occur in real world applications. For example, “approximately” and “about” may modify dimensions that may not be exact due to at least one of manufacturing tolerances or other real-world imperfections. Unless otherwise stated, “about,” “approximately,” or “substantially” preceding a value means+/−10 percent of the stated value, or, if the value is zero, a reasonable range of values around zero.

Modifications are possible in the described examples, and other examples are possible, within the scope of the claims.

From the foregoing, it will be appreciated that example systems, apparatus, articles of manufacture, and methods have been described that divide the Doppler domain spectrum for an array of N_{TX} transmitter into N_{B} bands, map each of the N_{TX} transmitters to one of N_{B} bands such that the Doppler domain spectrum for the array of transmitters includes N_{EB} empty bands that are not contiguous (e.g., N_{EB}=N_{B}−N_{TX}), and assign a phase change to each of the N_{TX} transmitters based on the mapping. As such, examples described herein determine an optimal, non-uniform mapping of Doppler bands to transmitters. Accordingly, example systems, apparatus, articles of manufacture, and methods have been described that improve DDMA performance by 3 dB for 16 transmitters and 1 dB for eight transmitters.

Described systems, apparatus, articles of manufacture, and methods improve the efficiency of using a computing device by increasing the SNR range across which a radar can accurately disambiguate transmitters without increasing computational complexity. As such, example radars described herein can improve ADAS and other radar applications such as in automation and robotics. Described systems, apparatus, articles of manufacture, and methods are also directed to one or more improvement(s) in the operation of a machine such as a computer or other electronic, electromechanical, or mechanical device.

What is claimed is:

1. A device comprising:
a plurality of transmit antennas; and
a plurality of transmitters coupled to the plurality of transmit antennas and including respective phase shifters, the respective phase shifters configured to apply respective phase changes between chirps of a frame such that a phase spectrum for the plurality of transmitters is divided into a plurality of bands, at least three of the respective phase changes being non-consecutively distributed along divisions of the phase spectrum.

2. The device of claim 1, wherein a first number of bands in the plurality of bands is equal to a sum of a second number of transmitters in the plurality of transmitters and a third number of the divisions of the phase spectrum along which none of the respective phase changes are to be distributed.

3. The device of claim 2, wherein each band in the plurality of bands is offset from each other band in the plurality of bands by a multiple of (2π/N), and N is the first number of bands.

4. The device of claim 1, wherein the respective phase changes are distributed along respective ones of the divisions of the phase spectrum.

5. The device of claim 1, wherein the device includes a Doppler division multiple-access radar device.

6. The device of claim 1, wherein the plurality of transmitters includes:
a first transmitter having a first index and including a first phase shifter, the first phase shifter configured to apply a first phase change between the chirps of the frame;
a second transmitter having a second index consecutive to the first index and including a second phase shifter, the second phase shifter configured to apply a second phase change between the chirps of the frame; and
a third transmitter having a third index consecutive to the second index and including a third phase shifter, the third phase shifter configured to apply a third phase change between the chirps of the frame, a first difference between the first phase change and the second phase change being different than a second difference between the second phase change and the third phase change.

7. The device of claim 1, wherein the frame is a first frame, the plurality of bands is a plurality of first bands, and the device further includes:
at least one receiver configured to receive second frames of reflected chirps from an object within a field of view of the device; and
at least one processor circuit to generate a Doppler representation of the second frames of the reflected chirps, the Doppler representation including a plurality of second bands where the object is represented in at least a portion of the plurality of the second bands and the at least three of the respective phase changes being non-consecutively distributed along the divisions of the phase spectrum causes the Doppler representation to include at least two non-contiguous bands in which the object is not represented.

8. The device of claim 7, wherein the plurality of second bands of the Doppler representation includes a plurality of third bands and the at least two non-contiguous bands, each of the plurality of transmitters associated with one of the plurality of third bands, the at least two non-contiguous bands not associated with any of the plurality of transmitters.

9. The device of claim 7, wherein the reflected chirps are first reflected chirps, the Doppler representation is a first Doppler representation, and, based on determining that the first Doppler representation includes less than a threshold number of objects, one or more of the at least one processor circuit is to cause the respective phase shifters of the plurality of transmitters to adjust the respective phase changes to cause a second Doppler representation of third frames of second reflected chirps to include a larger number of non-contiguous bands in which the object is not represented.

10. The device of claim 1, further including a lookup table (LUT) coupled to the respective phase shifters, the LUT to store values corresponding to the respective phase changes.

11. A device comprising:
a first transmitter having a first index in an array of transmitters, the first transmitter configured to transmit a first frame of chirps having a first phase change between the chirps of the first frame;
a second transmitter having a second index in the array of transmitters consecutive to the first index, the second transmitter configured to transmit a second frame of chirps having a second phase change between the chirps of the second frame; and
a third transmitter having a third index in the array of transmitters consecutive to the second index, the third transmitter configured to transmit a third frame of chirps having a third phase change between the chirps of the third frame, a first difference between the first phase change and the second phase change being different than a second difference between the second phase change and the third phase change.

12. The device of claim 11, further including:
at least one receiver configured to receive fourth frames of reflected chirps from an object within a field of view of the device; and
at least one processor circuit to generate a Doppler representation of the fourth frames of the reflected chirps, the Doppler representation including bands where the object is represented in at least a portion of the bands and the first difference being different than the second difference causes the Doppler representation to include at least two non-contiguous bands in which the object is not represented.

13. The device of claim 12, wherein the bands of the Doppler representation include first bands and the at least two non-contiguous bands, each of the first transmitter, the second transmitter, and the third transmitter associated with one of the first bands, the at least two non-contiguous bands not associated with any transmitter of the device.

14. The device of claim 12, wherein the first difference being different than the second difference causes the Doppler representation to include:
a first band in which the object is not represented;
a second band contiguous with the first band and in which the object is represented; and
a third band contiguous with the second band and in which the object is not represented.

15. The device of claim 12, wherein the at least one processor circuit is to:
for potential mappings of the first transmitter, the second transmitter, and the third transmitter and the at least two non-contiguous bands to the Doppler representation, compute sums of energy in respective bands of the Doppler representation in which the object is to be represented according to the potential mappings; and
select, as a candidate mapping of the first transmitter, the second transmitter, and the third transmitter to the Doppler representation, one of the potential mappings that has a largest sum of energy among the potential mappings.

16. The device of claim 12, wherein the reflected chirps are first reflected chirps, the Doppler representation is a first Doppler representation, and, based on determining that the first Doppler representation includes less than a threshold number of objects, one or more of the at least one processor circuit is to cause respective phase shifters of the array of transmitters to adjust respective phase changes to cause a second Doppler representation of fifth frames of second reflected chirps to include a larger number of non-contiguous bands in which the object is not represented.

17. The device of claim 11, further including a lookup table (LUT) coupled to the first transmitter, the second transmitter, and the third transmitter, the LUT to store values corresponding to the first phase change, the second phase change, and the third phase change.

18. The device of claim 17, further including at least one processor circuit to program the LUT with the values, the values determined based on simulation of potential positions of at least two non-contiguous bands in a Doppler representation of fourth frames of reflected chirps from an object within a field of view of the device, the at least two non-contiguous bands not including a representation of the object.

19. The device of claim 11, wherein the device includes a Doppler division multiple-access radar device.

20. A method comprising:
applying, with respective phase shifters of a plurality of transmitters, respective phase changes between chirps of a frame such that a phase spectrum for the plurality of transmitters is divided into a plurality of bands, at least three of the respective phase changes being non-consecutively distributed along divisions of the phase spectrum; and
transmitting, via a plurality of transmit antennas coupled to the plurality of transmitters, respective frames of chirps having the respective phase changes.
